(19) United States
(12) Patent Application Publication
(10) Pub. No.: US 2009/0205520 A1
(43) Pub. Date: Aug. 20, 2009

(54) Drive units of a rotating component of a printing press

(76) Inventors: Karl Robert Schäfer, Kürnach (DE); Bernd Kurt Masuch, Kürnach (DE); Georg Schneider, Würzburg (DE)

Correspondence Address: JONES, TULLAR & COOPER, P.C., P.O. BOX 2266 EADS STATION, ARLINGTON, VA, 22202, US

(21) Appl. No.: 11/921,794

(22) PCT Filed: Jun. 21, 2006
(86) PCT No.: PCT/EP2006/063393

§ 371 Date: Dec. 7, 2007

(30) Foreign Application Priority Data
Jun. 23, 2005 (EP) 05105635.6
Oct. 5, 2005 (DE) 10 2005 047 660.0

(51) Int. Cl. B41F 5/00

(52) U.S. Cl. 101/216

(57) ABSTRACT

A drive unit is provided for a rotating component of a printing press, which rotating component is disposed between spaced lateral frames. A bearing assembly supports the rotatable component so that it is movable in a direction of movement which is perpendicular to the axis of rotation of the rotatable component. A journal of the rotatable component does not penetrate an alignment of the lateral frame in its mounted orientation. The rotatable component is rotatably driven by an independent drive motor. A rotor of the drive motor is joined to the journal of the rotatable component in a torsion-proof, detachable configuration. A bearing assembly for the journal is provided with a movable bearing block that receives the journal of the rotatable component, and which is located on an interior portion of the bearing assembly, relative to the plane of the lateral frame. A stator of the driving motor is rigidly, and removably connected to the movable bearing block.

### CROSS-REFERENCE TO RELATED APPLICATIONS

This application is the U.S. national phase, under 35 USC 371, of PCT/EP2006/063393, filed Jun. 21, 2006; published as WO 2006/136578 A1 on Dec. 28, 2006 and claiming priority to DE 05 105 635.6, filed Jun. 23, 2005, and to DE 10 2005 047 660.0, filed Oct. 5, 2005, the disclosures of which are expressly incorporated herein by reference.

### FIELD OF THE INVENTION

The present invention is directed to drive units for a rotating cylinder of a printing press with end surface journals. The cylinder is configured as one of a forme cylinder and a transfer cylinder of a blanket-to-blanket printing group. The cylinder is arranged in side frames and is movable via a bearing assembly in a direction of adjustment which is perpendicular to an axis of rotation of the rotating cylinder. The end surface journals do not project through the respective side frames.

### BACKGROUND OF THE INVENTION

EP 0 699 524 B1 describes drive trains for printing units. In one embodiment, the printing group cylinder is driven separately by an independent motor. In one configuration of the drive motor, its rotor, which is provided with windings, is capable of moving axially in relation to a stationary stator.

DE 195 34 651 A1 describes a printing unit with cylinders that lie in a single plane. Three of four cylinders are mounted so as to be linearly movable along the cylinder plane for the purpose of print-on or print-off adjustment. Mounting is accomplished in guide elements which are arranged on the inner panel of a frame. The cylinders are seated in supports on the shared guide elements, are capable of being either engaged against one another or disengaged from one another by the use of working cylinders which are actuated with pressure medium, and can be rotated via drive motors.

In WO 02/081218 A2 individual linear bearings for two transfer cylinders, each mounted in carriages, are known. Each carriage is mounted on an insert that projects out of the alignment of the side frame into the direction of the cylinders. The cylinders are driven in pairs or individually via separate drive motors. The motor in the represented embodiment can be stationary in configuration and can be carried along in a manner which is not described in greater detail.

In WO 03/025406 A1 a bearing assembly for cylinders is disclosed. A carriage that encompasses a linear guide can be moved by an actuator that is arranged on the frame.

EP 1175 300 B1 specifies a flexographic printing press with a forme cylinder that is driven directly on the journal. The motor is mounted on a sliding block, which is arranged on a supporting shoulder of the machine frame.

### SUMMARY OF THE INVENTION

The object of the present invention is to provide rotating cylinders of a printing press, with end-surface journals having drives that are simple in construction but nonetheless powerful.

The object is attained according to the invention with the provision of the rotating cylinder, either as a forme cylinder or as a transfer cylinder capable of moving via a bearing assembly in a direction of adjustment perpendicular to a cylinder axis of rotation. The end-surface journals of either cylinder do not project through the laterally spaced side frames. Each such cylinder is rotatably driven by its own drive motor. The bearing assembly has a movable bearing block, which is configured to accommodate the journals of the respective cylinder which is positioned on the inside of the bearing assembly.

The benefits to be achieved with the present invention consist especially in that a particularly simple drive unit for an independently actuated, movably mounted rotational component of the printing press is provided. The special configuration of the bearing, the short journals and the detachable positioning of the motor on the movable bearing block or on the side frame result in a particularly simple assembly and structure, and additionally serve to minimize vibration. Furthermore, in a particular embodiment of the present invention, motors, which may be energized by a permanent magnet, provide a particularly powerful drive with small dimensions for the rotational component.

In one advantageous embodiment of the present invention, in which mounting inside the motor between the stator and rotor can be dispensed with, the motor is particularly simple in construction and/or is particularly low-maintenance in terms of its wearing parts.

In one advantageous embodiment of the present invention, and involving a permanently excited motor, the motor is configured to have a particularly high power output while the dimensions are kept small. Additionally, with this, electric transmission components, such as sliding contacts on a rotating component, such as, for example, on the rotor, are eliminated when the rotor has permanent magnets rather than electromagnetically energized coils for generating the magnetic field.

In one advantageous embodiment of the drive motor of the present invention, the stator is not arranged fixed to the frame or the bearing in an axial direction. Rather, at least to a certain degree, it is disposed so as to be axially movable. However, it can be configured to be secured against any occurring torque, for example relative to the side frame and/or a bearing unit. Now, if, for example, a rotor that is capable of moving axially along with the cylinder, is moved axially, the stator can be moved axially along with it by virtue of magnetic interaction, such that the magnets of the stator and the rotor can remain at the optimal operating point in relation to one another. In an extreme case the stator can remain stationary, as viewed in relation to the rotor.

Conversely, in another advantageous embodiment of the drive motor of the present invention, the stator can be arranged fixed to the frame or to the bearing, in an axial direction. The rotor element that holds the magnets is capable of moving axially, at least to a certain degree, relative to a shaft that is fixed in relation to the cylinder. With respect to torque to be transmitted, the rotor element is secured against torsion in relation to the cylinder and/or the shaft. In this case, for example, if the cylinder is moved axially, the rotor is not forced into axial motion along with it. Rather, as a result of magnetic interaction with the stator, the rotor can remain in place axially, in extreme cases stationary, such that the magnets of the stator and the rotor remain at the optimal operating point in relation to one another.

By using linear guides for the printing group cylinder, an ideal installed position for the cylinder, with respect to potential cylinder vibrations, is achieved. In addition, mounting the cylinder in linear guides allows short adjustment paths to be realized. Therefore, no synchronizing spindle is necessary. The costly installation of three-ring bearings is eliminated.

Mounting on the inside of the side frames, in addition to simplifying installation, allows the cylinder journals to be shortened, which serves both to minimize vibrations and to save on space.

In one advantageous embodiment of the present invention, in which the stator is arranged on the movable bearing block, a simple coupling of cylinder and motor is achieved.

The further improvement of the linear bearing, with movable stops, enables a pressure-based adjustment of the cylinder, together with an automatic basic setting adjustment, for a new configuration, for a new printing blanket, and the like.

### BRIEF DESCRIPTION OF THE DRAWINGS

Preferred embodiments of the present invention are represented in the set of drawings and will be described in greater detail in what follows.

The drawings show:

FIG. 1 a schematic representation of a printing unit;

FIG. 2 a first operating position of a first embodiment of a printing unit in accordance with the present invention;

FIG. 3 a second operating position of a first preferred embodiment of a printing unit;

FIG. 4 a schematic representation of a modular configuration of a printing unit;

FIG. 5 a plan view of a blanket-to-blanket printing group;

FIG. 6 a schematic longitudinal view, partly in cross-section of a bearing unit;

FIG. 7 a schematic side elevation view of a bearing unit in accordance with the present invention;

FIG. 8 an enlarged representation, partly in cross-section, of the linear bearing of FIG. 6;

FIG. 9 a coupling of a cylinder on a lateral register drive;

FIG. 10 a coupling of a drive motor to a cylinder which is not a part of the present invention;

FIG. 11 an embodiment of the drive unit of a printing group, which is not a part of the present invention;

FIG. 12 a second embodiment of the coupling of a drive motor to a cylinder;

FIG. 13 a schematic, perspective representation of a rotor;

FIG. 14 a further schematic, perspective representation of a stator;

FIG. 15 a variation of the drive motor depicted in of FIG. 12, which is not a part of the present invention;

FIG. 16 a variant of the drive motor of FIG. 12, which is not a part of the invention;

FIG. 17 a variant of the drive motor of FIG. 12, which is not a part of the invention;

FIG. 18 a variant of the drive motor of FIG. 12, which is not a part of the invention;

FIG. 19 an embodiment of the drive unit for a rotating body, especially a cylinder, which is not a part of the invention;

FIG. 20 a variant of the drive unit for a rotating body, especially a cylinder which is not a part of the invention;

FIG. 21 an axially offset arrangement of adjacent drive motors;

FIG. 22 a segmented embodiment of the drive unit for a rotating component, especially a cylinder, which is not a part of the invention;

FIG. 23 variants of a segmented drive motor with an axially parallel arrangement;

FIG. 24 variants of a segmented drive motor with an axially vertical arrangement, which are not a part of the invention;

FIG. 25 variants of a segmented drive motor with an axially vertical arrangement;

FIG. 26 variants of a segmented drive motor with an axially vertical arrangement, which are not a part of the invention;

FIG. 27 arrangements of stator segments of adjacent drive motors;

FIG. 28 an embodiment of a stator segment for a movable component, which is not a part of the invention;

FIGS. 29a, b, and c, variants of the control of stator segments;

FIG. 30 a further embodiment of the coupling of the drive motor to a rotating component with an integrated axial drive;

FIG. 31 a schematic depiction illustrating the principle of operation of a printing press;

FIG. 32 a side elevation view, partly in section, of a reel changer;

FIG. 33 a schematic depiction of a folding structure;

FIG. 34 a schematic side elevation representation of a folding unit;

FIG. 35 a schematic side elevation representation of a second embodiment of a folding unit;

FIG. 36 a schematic side elevation representation of a third embodiment of a folding unit;

FIG. 37 a preferred embodiment of a drive unit for a printing press.

### DESCRIPTION OF THE PREFERRED EMBODIMENTS

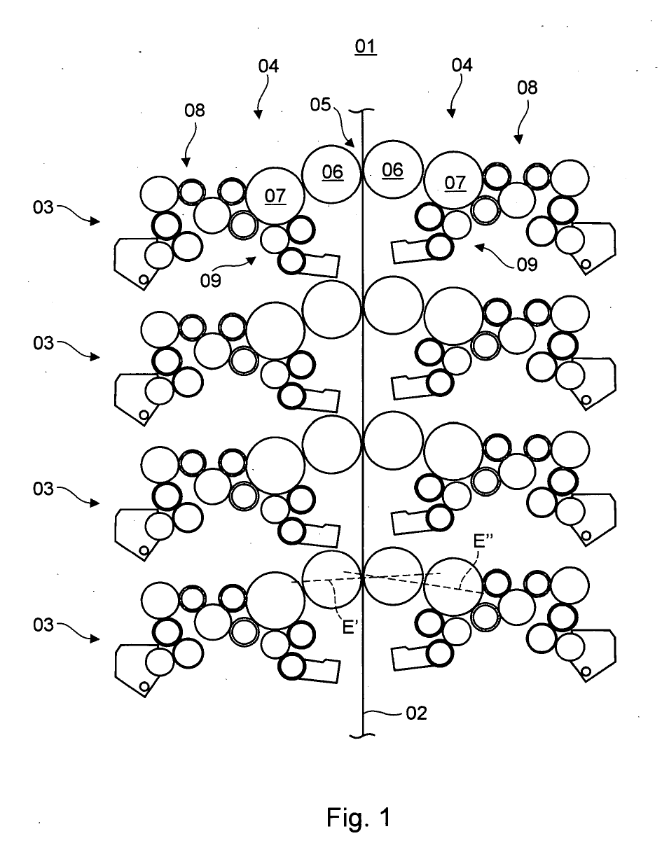

A printing press, such as, for example, a web-fed rotary printing press, and especially a multicolor web-fed rotary printing press, as depicted schematically in FIG. 1, has a printing unit 01, in which a printing substrate 02, such as, for example, a material web 02, referred to hereinafter as web 02, can be printed on both sides a single time, or preferably can be printed on both sides multiple times in sequence. Alternatively, a plurality of webs can be printed simultaneously in a single or in a multi-step operation, by printing groups 04. One or more printing units 01 or printing groups 04 can also be provided, in which units 01 or groups 04, a web 02 can be printed at a printing point 05 on only a single side. The printing groups 04 have printing group cylinders 06; 07, which are engaged against one another in pairs in the print-on position.

The solutions which will be demonstrated, discussed and depicted in what follows can also be advantageously applied to printing groups 04 in which the printing substrate 02 is in the form of sheets rather than one or more webs.

The particular advantage, in accordance with the present invention, is that one or more of the printing group cylinders 06; 07 and/or one or more of the other rotating components have their own separate drive motor, mechanically independent at least from other printing groups 04 or from other units, as will be discussed subsequently. Each such separate drive motor is preferably positioned essentially coaxially to the printing group cylinder 06; 07 and, in an advantageous embodiment, is coupled to the printing group cylinder 06; 07 without an interposed transmission.

The configuration and the coupling of the drive motor can be structured in a variety of ways, and will be described in greater detail in what follows. These embodiments can also be used in printing groups 04 or in printing units 01, or for other driven rotating components having a very large variety of configurations. In the discussion which follows, the use is described within the context of an advantageous embodiment of a printing unit 01 and/or in the contest of an advantageous embodiment of a printing group 04.

The printing unit 01 of the present preferred embodiment has multiple, and in the present case has four blanket-to-blanket printing groups 03 which are arranged vertically one above another for printing on both sides in a blanket-to-blanket operation, all as depicted in FIG. 1. The blanket-to-blanket printing groups 03, which are represented here in the form of arch-type or n-printing units, are each formed by two cooperating printing groups 04, each of which has cylinders 06; 07, one being configured as a transfer cylinder 06 and the other one being configured as a forme cylinder 07, such as, for example, printing group cylinders 06; 07, and one inking unit 08, and, in the case of wet offset printing, also a dampening unit 09. In each case, between the two transfer cylinders 06, at the position of engagement, a blanket-to-blanket printing point 05 is formed. In FIG. 1, the above-described component parts are identified only in the uppermost blanket-to-blanket printing group 03. However, the blanket-to-blanket printing groups 03; 04, which are arranged one above another, are essentially identical in configuration especially in the embodiment of the features which are relevant to the present invention. In contrast to the representation of FIG. 1, the blanket-to-blanket printing groups 03 can be implemented just as beneficially as a U-shaped unit that is open toward the top, without the advantageous feature of the linear arrangement, as will be described below.

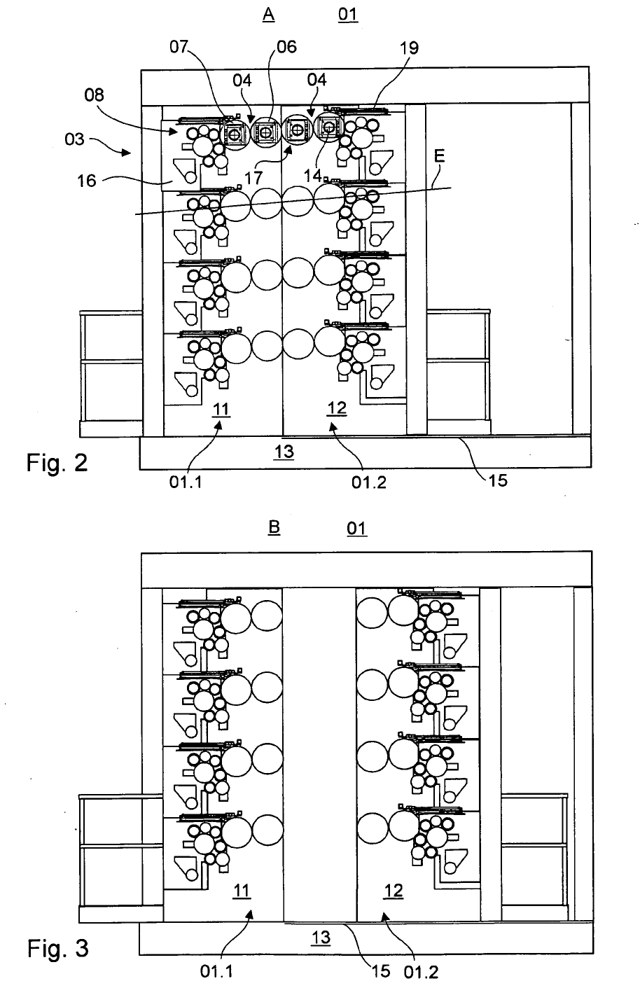

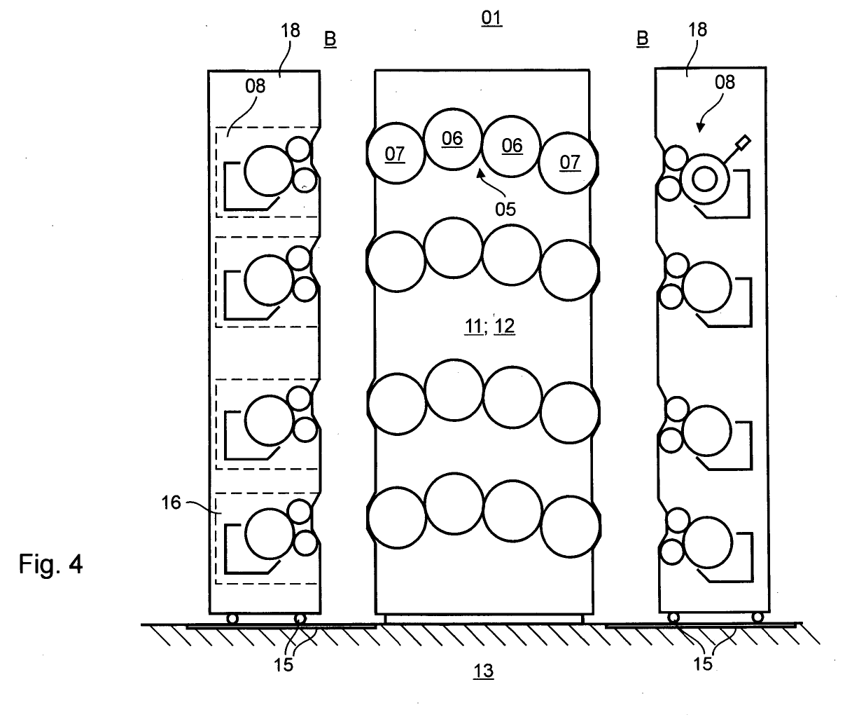

As described, taken with reference to FIGS. 2 and 3, in an advantageous embodiment, the printing unit 01 can be configured to be operationally separable, such as, for example, centrally, or in the area of the blanket-to-blanket printing pointor points 05, or, as represented in FIG. 4, between the forme cylinder 07 and the inking unit 08.

In the upper blanket-to-blanket printing group 03 of FIG. 2, bearing assemblies 14 are represented by way of example, which bearing assemblies 14 enable a movement of the respective cylinder 06; 07 in a direction which is perpendicular to the respective cylinder's axis of rotation, such movement being, for example, for the purpose of on/off adjustment. In principle, this bearing assembly can be an eccentric bearing assembly, a lever assembly or, in one advantageous embodiment, as will be described below, can be a linear bearing assembly 14, such as, for example, a bearing unit 14.

As is also depicted, by way of example in FIGS. 2 and 4, the inking units 08, and, if applicable, also the dampening units 09 can each be configured as modules, each comprising a plurality of rollers with their own frame 16 or framework 16, and each of which can be installed into the printing unit 01 as pre-installable modules. As described in greater detail below, the cylinders 06; 07, with their respective bearing units 14, can be configured as pre-mountable or as pre-mounted cylinder units 17. In an advantageous embodiment, as shown in FIG. 2, the rotational axes of the printing group cylinders 06; 07 of a printing group 04 can be configured to lie essentially within a shared plane E in the print-on position. The plane E forms an angle measuring, for example, between 76 degrees and 87 degrees, and especially between 80 degrees and 85 degrees, with respect to the plane of the incoming web 02, which, as depicted in FIG. 2, is generally vertical.

In FIGS. 2 and 3, an advantageous embodiment of the printing unit 01, in accordance with the present invention, is represented. That embodiment is configured such that it can be functionally separated in the area of its blanket-to-blanket printing point, or points, 05, in other words for set-up and maintenance purposes, as compared with dismantling or a disassembly purpose. The two parts that can be separated from one another are referred to in what follows as printing unit sections 01.1 and 01.2.

In addition, the printing group cylinders 06; 07 of the multiple, typically four blanket-to-blanket printing groups 03, which are stacked one above another, are each rotatably mounted in, or on, one right and one left frame or panel section 11; 12, for example each on side frame or panel 11; 12, respectively in such a manner that both of the two printing group cylinders 06; 07 of the same printing group 04 are allocated to the same frame or panel section 11; 12. The printing group cylinders 06; 07 of multiple printing groups 04, and especially all of the printing groups 04 that print the web 02 on the same side, are preferably mounted on the same frame or panel section 11; 12. In principle, the printing group cylinders 06; 07 can each be mounted on only one end, or each cantilevered, on only one outside-surface frame section 11. Preferably, however, two frame sections 11; 12 which are positioned at the two spaced ends of each of the cylinders 06; 07, are provided for each printing unit section 01.1; 01.2. The two printing unit sections 01.1 and 01.2 that can be separated from one another comprise the respective frame sections 11; 12 and printing groups 04, each group 04 including printing group cylinders 06; 07 and inking units 08, and, if applicable, dampening unit 09.

The printing unit sections 01.1; 01.2 can be moved toward one another, and can be moved away from one another in a direction that runs perpendicular to the axis of rotation of the cylinders 06; 07, in a configuration in which one of the two printing unit sections 01.1; 01.2 is preferably mounted fixed in place, in this case the printing unit section 01.1 for example by being positioned stationarily on a section of floor 13 in the printing shop, on a stationary support 13, on a mounting plate 13 or on a mounting frame 13 for the printing unit 01. The other, in this case the printing unit section 01.2 is mounted so as to be movable in relation to the floor 13 or support 13 or mounting plate 13 or mounting frame 13, hereinafter referred to as support 13.

To this end, the outer frame sections 12 are mounted in bearing elements of the frame section 12 and the support 13, which bearing elements correspond to one another and are not specifically shown here, and which, for example, together form a linear guide 15. These bearing elements can be configured as rollers that run on tracks or as sliding or roller-mounted linear guide elements that are allocated to one another.

The panel sections 11; 12 are preferably structured such that in their operational position A, as seen in FIG. 2 their sides that face one another are configured to have essentially complementary shapes in pairs, and to form an essentially closed side front at their separation lines and/or impact lines, when they are pushed together.

FIG. 3 shows a maintenance position B for the printing unit 01, without the bearing units 14 shown in FIG. 2, wherein the positioning of the printing unit sections 01.1; 01.2 in relation to one another is effected by moving the movable frame section 12. In principle, this relative positioning can also be accomplished, in another embodiment, in which both printing unit sections 01.1; 01.2 and/or their frame sections 11; 12 are mounted so as to both be movable.

In one variation, as depicted in FIG. 4, of a separable printing unit 01, the side frame 11; 12 is not separable such that the printing group cylinders 06; 07 are separated at the printing point 05, as shown in FIG. 3. Instead, the printing group cylinders 06; 07 are inseparably mounted in or on a shared side frame 11; 12. Panel sections 18, that accommodate the inking units 08, can be placed in an operating position A, which is not shown, or in a maintenance position B, which is shown. In this case, separation occurs between the forme cylinder 07 and the inking and, if applicable, dampening unit 08; 09.

In one advantageous format variation, the forme and transfer cylinders 07; 06 can be configured to have a cylinder width of at least four vertical print pages, for example four such pages or even for a particularly high rate of production six, vertical print pages in newspaper format, and especially in broadsheet format, with the sheets being arranged side by side. Thus, a double-width web 02 can be printed with four newspaper pages side by side, and a triple-width web 02 can be printed with six newspaper pages side by side, and the forme cylinder 07 can be correspondingly covered with four printing formes or with six printing formes arranged side by side, especially with their ends aligned with one another. In a first format embodiment, the circumference of each of the cylinders 06; 07 corresponds essentially to two print pages in newspaper format, especially in broadsheet format, arranged in tandem.

In the embodiments of the printing unit 01 with forme cylinders 07 of double-sized format, with two newspaper pages arranged in tandem in circumference, the printing unit advantageously has two channels, which are offset at 180 degrees relative to one another in the circumferential direction, to accommodate the printing formes, which printing formes are preferably configured to be continuous over the entire active surface length. The forme cylinder 07 can then be loaded with four printing formes or with six printing formes side by side, and with two printing formes in tandem in circumference.

In one embodiment, such as, for example, in the double-sized format, with two newspaper pages in tandem in circumference the transfer cylinder 06 has only one channel configured to accommodate one or more printing blankets arranged side by side, which one channel is preferably configured to be continuous over the entire active surface length. The transfer cylinder 06 can then be loaded with one printing blanket that is continuous over the surface length and which extends over essentially the full circumference, or with two or three printing blankets situated side by side, with each extending over essentially the full circumference of the transfer cylinder. In another embodiment of the double-sized transfer cylinder 06, that cylinder can have two or three printing blankets situated side by side, with the respective adjacent blankets being offset 180 degrees in relation to one another in the circumferential direction. These offset printing blankets can be held in two or three channel sections, which also are positioned side by side in the longitudinal direction of the cylinder 06, while the respective adjacent channel sections are offset 180 degrees in relation to one another in the circumferential direction.

In another embodiment, however, the cylinders 06; 07 can also be configured to have a single circumference, with one printed page, especially a newspaper page, in the circumferential direction. The transfer cylinder 06 can also be configured to have a double circumference and the forme cylinder 07 can have a single circumference. In printing groups 04, which are intended for use in commercial printing, the cylinders 06; 07 can also be configured to have circumferences that corresponds to four horizontal tabloid pages.

In principle, the inking unit 08 can have various configurations. For instance, as is represented by way of example in FIG. 1, the inking unit 08 can be configured as a single-train roller inking unit 08, with, for example, two distribution cylinders, for example for use for newspaper printing, or as is represented by way of example in FIG. 2 and FIG. 3 as anilox inking units 08 that utilize an anilox roller having cells or hash marks. In an embodiment which is not specifically shown here, the inking unit 08 can also be configured as a roller inking unit 08 with two inking trains and with, for example, three distribution cylinders, for example for use for commercial printing.

In the case of dry offset printing, one inking unit 08 is provided for each printing group 04, but no dampening unit 09 is provided. In wet offset printing, dampening agent is supplied via the dampening unit 09, which may be strictly separated from the inking unit 08 or which may be connected in parallel to the inking unit 08 via an arch-type roller.

The dampening unit 09 can be configured as a dampening unit 09 having at least three rollers, as is shown in FIG. 1. Preferably, the dampening unit 09 is configured as a so-called contactless dampening unit 09, and especially as a spray dampening unit 09. As is also indicated in FIGS. 2 and 3, the printing groups 04 can each have a handling device 19 that is intended to aid in the exchange of printing formes. In a preferred embodiment, the handling device 19 is configured as being an at least partially automated or even as a fully automated printing forme changer 19.

Independently of the advantageous configuration, as will be described below, of the mount as a bearing unit 14, of its special structuring and positioning, and of the coupling of the drive unit to the cylinders 06; 07, an adjustment of printing group cylinders 06; 07 to the print-on position, or at least a print-on adjustment in the context of the pre-setting of a travel-limiting stop, can be accomplished by the use of at least one actuator 43, and especially an actuator 43 that is power-controlled or which is defined by a force, and which is capable of applying a defined or a definable force F to the cylinder 06; 07 or to its journal 21; 22 in the print-on direction to accomplish adjustment. The linear force at the nip points, which linear force, among other factors, is decisive for ink transfer and for print quality, is thus defined not by an indirect parameter, such as a measured printing test strip, but by the equilibrium of forces between the force F and the linear force F_{L} that results between the cylinders 06; 07, and the resulting equilibrium.

The actuator 43, which is provided in the preceding embodiment of the bearing units 14, is configured to furnish an adjustment path ΔS that is suitable for on or off adjustment, and thus preferably has a stroke that corresponds at least to ΔS. The actuator 43 is provided for adjusting the contact pressure of rollers or cylinders 06, 0, which are engaged against one another, and/or for performing the adjustment to the print-on/print-off position, and is configured accordingly. The adjustment path ΔS, or the linear stroke amounts, for example, to at least 0.5 mm for the forme cylinder 07, and especially amounts to at least 1 mm.

For the basic adjustment of a system, it is therefore provided, in one preferred embodiment, that for a certain period of time during adjustment, at least one cylinder 06, 07, can be adjusted in relation to the adjacent cylinder 06, 07 solely under force control, without effective travel limitation toward the printing point 05. At least for a specific time period during the adjustment process, a cylinder 06 that is engaged at the printing point 05 can be affixed in a defined position, advantageously in the position of adjustment defined by the equilibrium of forces, or at least its travel in the direction of the printing point 05 can be limited.

In the discussion which follows, the principle of power-controlled adjustment, at least during the positioning process will be described in greater detail in the context of advantageous embodiments of the mounting arrangement and the actuation system.

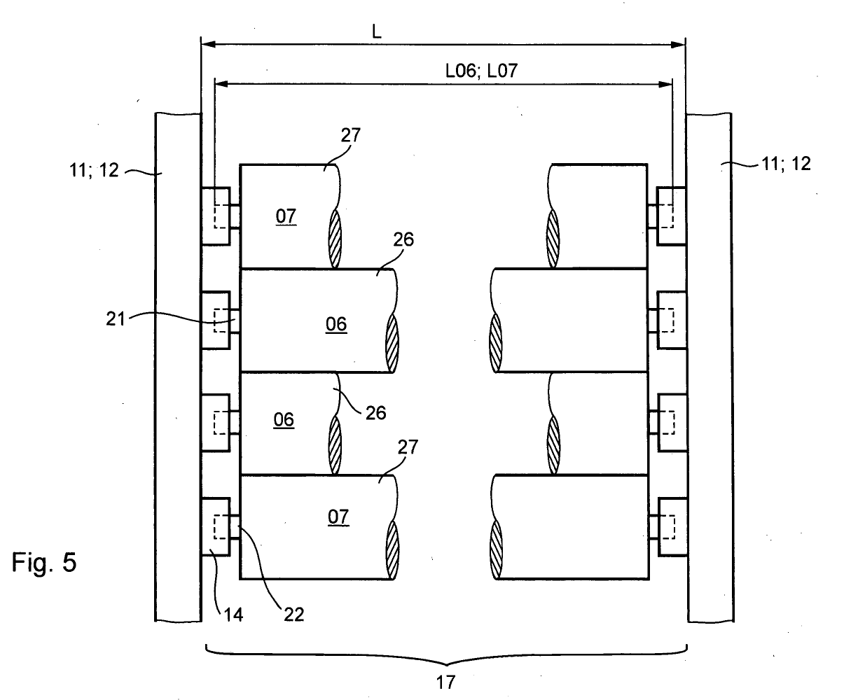

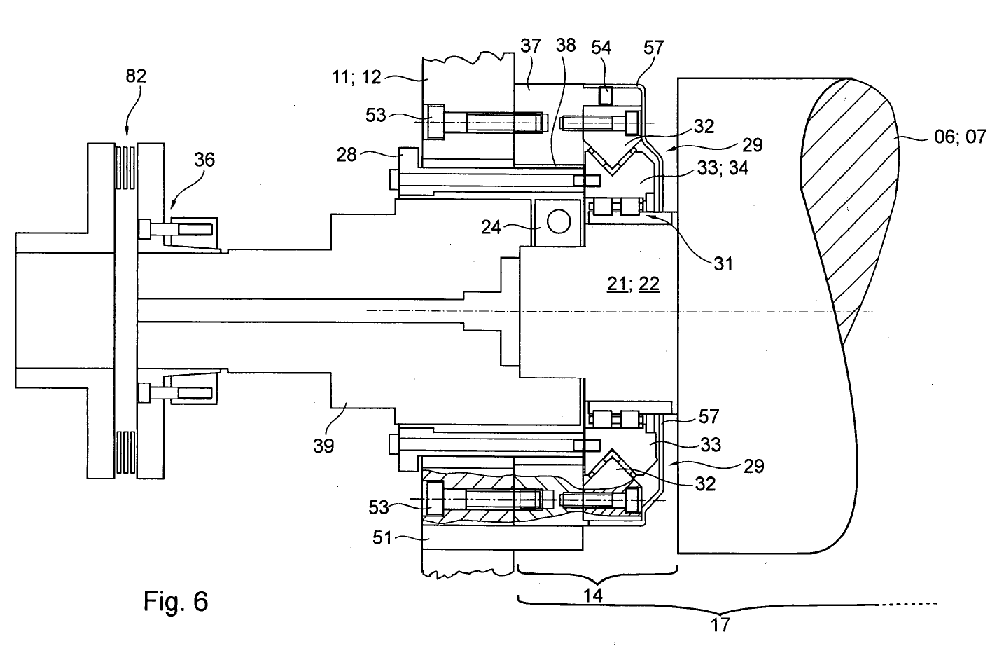

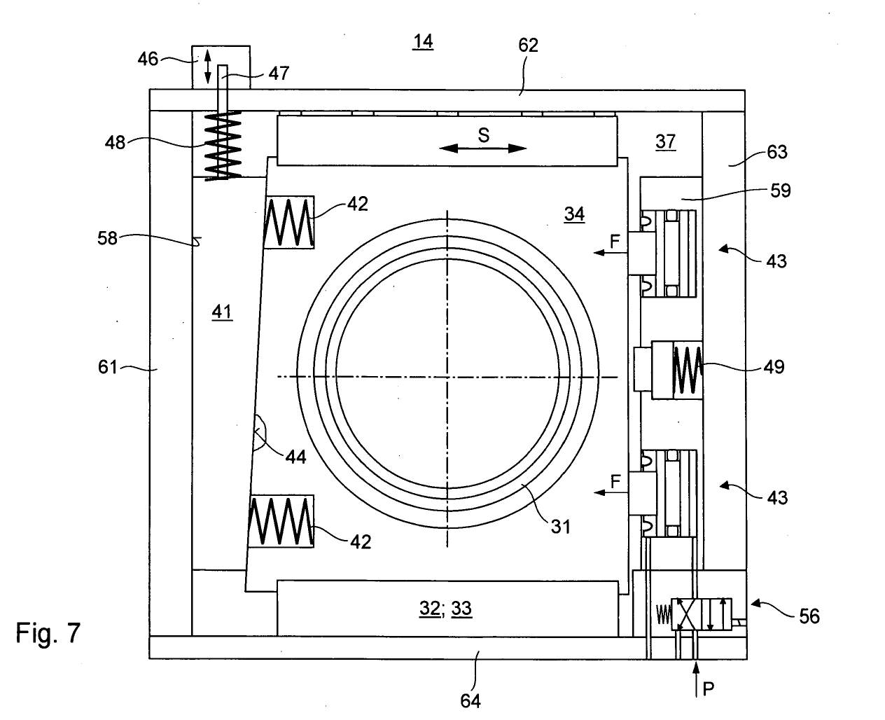

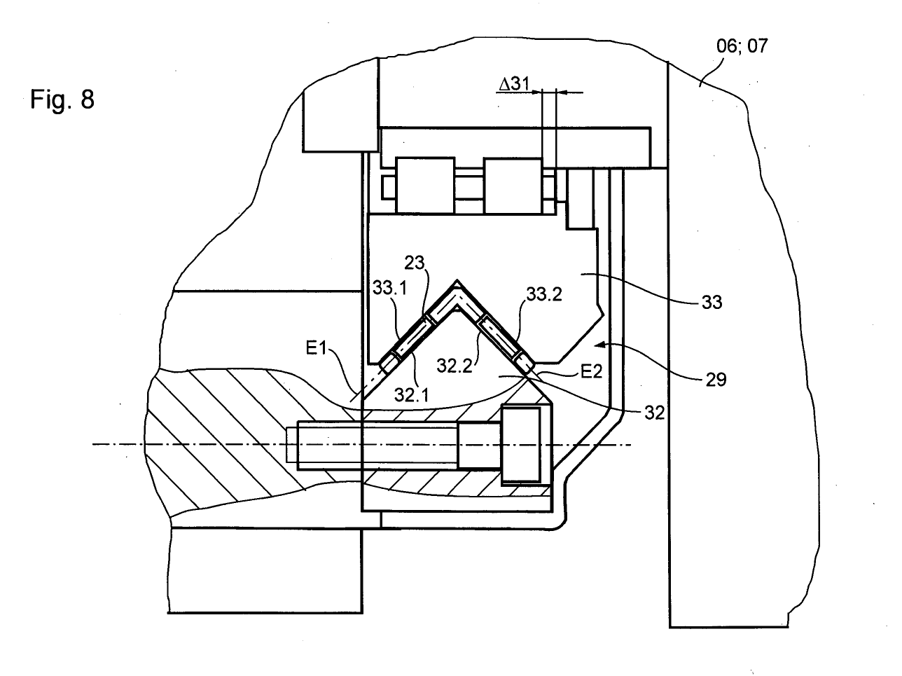

FIG. 5 shows a plan view of cylinders 06; 07 that are rotatably mounted in bearing units 14 on side frames. In the embodiment that contains modules, these are configured as cylinder units 17, as may be seen with reference to FIGS. 6 and 7, and have, for example, a cylinder 06; 07 with journals 21; 22 and a bearing unit 14 that is already mounted, either prestressed and/or prepositioned on the cylinder journal 21; 22. Bearing unit 14 and cylinder 06; 07 are given their firmly defined position, in relation to one another, before being installed in the printing unit 01, and can be installed in the printing unit 01 as a complete unit.

In one advantageous embodiment of the printing unit 01, the cylinders 06; 07 can be rotatably mounted in bearing units 14 which are positioned on the side frames 11; 12, and which cylinders do not penetrate the alignment of the side frames 11; 12. The cylinders 06; 07, including their barrels 26; 27 and their journals 21; 22, have a length L06; L07, which is smaller than, or equal to an inside width L between the side frames 11; 12 that support the printing unit cylinders 06; 07 at both end surfaces, as seen in FIG. 5. The side frames 11; 12 that support the printing unit cylinders 06; 07 at both end surfaces are preferably not side frames that are open at the sides to allow the cylinders 06; 07 to be removed axially. Rather the side frames 11; 12 overlap the end surface of the mounted cylinder 06; 07 at least partially in an axial direction, so that the cylinder 06; 07, and especially its bearing as is discussed below, is at least partially encompassed at the end surface by the two side frames 11; 12.

Preferably, each of the four printing group cylinders 06; 07, but at least three of the printing group cylinders has its own bearing unit 14, into which the on/off adjustment mechanism is already integrated. Bearing units 14 that have the on/off adjustment mechanism can also be provided for three of the four cylinders 06; 07, while bearing units without the on/off adjustment mechanism are provided for the fourth cylinder.

FIG. 6 and FIG. 7 show, in schematic longitudinal and elevation views, a bearing unit 14 that is preferably based upon the use of linear adjustment paths. The bearing unit 14 with the integrated on/off adjustment mechanism has, in addition to a bearing 31, such as, for example, a radial bearing 31, such as a cylindrical roller bearing 31, for the rotational mounting of the cylinder 06; 07, also has bearing elements 32; 33 which are configured to allow the radial movement of the cylinder 06; 07, for adjustment to the print-on or to the print-off position. In addition, the bearing unit 14 has bearing elements 32 which are fixed to the support, by being fixed to the frame once the bearing unit 14 has been mounted, and bearing elements 33 that can be moved in relation to these fixed bearing elements 32. The bearing elements that are fixed to the support, and those bearing elements that are movable 32; 33, are configured as interacting linear elements 32; 33 and, together with corresponding sliding surfaces or roller elements which are positioned between them, are configured as linear bearings 29. The linear elements 32; 33 accommodate, in pairs, a bearing block 34 between them, such as, for example, a carriage 34, which accommodates radial bearing 31. The bearing block 34 and the movable bearing elements 33 can also be configured as a single piece. The bearing elements 32, which are fixed to the support, are arranged on a support 37, which will be, or which is connected as a unit to the side frame 11; 12. For example, the support 37 may be implemented as a mounting plate 37, which has a recess 38, for example, at least on a drive side, for the penetration of a shaft 39, such as, for example, a drive shaft 39 for a journal 21; 22 of a cylinder 06; 07, which is not specifically illustrated in FIG. 7. The side frame 11; 12, on the drive side, is also preferably equipped with a recess or with an opening for a drive shaft 39. On the end surface of the side frame, opposite the drive side, it is not essential to provide a recess 38 or an opening in the side frame 12; 11.

Preferably, a length of the linear bearing 29, and especially at least a length of the bearing element 32 of the linear bearing 29, which, in its mounted state, is fixed to the frame, is smaller than a diameter of the allocated printing group cylinder 06; 07, viewed in the direction of adjustment S, as seen in FIG. 7.

The structuring of the linear bearing 29 in such a way that the interacting bearing elements 32; 33 are both provided on the bearing unit 14 component, and not on a part of the side frame 11; 12 of the printing unit 01, enables a preassembly and a presetting or an adjustment of the bearing tension. The advantageous arrangement of the two linear bearings 29 that encompass the bearing block 34, enables an adjustment free from play, since the two linear bearings 29 are arranged opposite one another in such a way that the bearing pre-tension and the bearing forces encounter or accommodate a significant force component in a direction that is perpendicular to the axis of rotation of the cylinder 06; 07. The linear bearings 29 can therefore be adjusted in the same direction as the play-free adjustment of the cylinder 06; 07. The arrangement of the linear bearings 29 also provides advantages especially in terms of rigidity and stability. This is particularly essential in connection with an embodiment of the present invention in which a stator 86, as is discussed below is coupled to the bearing block 34.

The linear bearings 29, 32, 33 identifiable in FIGS. 6 and 7, thus each have pairs of corresponding, interacting bearing elements 32 and 33 or their guide or active surfaces, which are configured as sliding surfaces, not specifically shown or with rolling elements 23 arranged between them. As is shown in FIG. 8, in the preferred embodiment, at least one of the two, and advantageously both of the linear bearings 29 of a bearing unit 14 are configured such that the two corresponding bearing elements 32 and 33 each have at least two guide surfaces 32.1; 32.2; 33.1; 33.2, which two guide surfaces for each bearing element lie in two planes that are inclined relative to one another. The two guide surfaces 32.1; 32.2; 33.1; 33.2, or their planes E1; E2 of the same bearing element 32; 33 are, for example, v-shaped relative to one another, as seen in FIG. 6. For example, they are inclined at an angle of between 30 degrees and 60 degrees relative to one another, and especially between 40 degrees and 50 degrees. The two guide surfaces 33.1; 33.2; 32.1; 32.2 of the interacting bearing element 33; 32 are inclined in relation to one another in a manner that complements their shape. At least one of the two pairs of interacting guide surfaces 32.1; 32.2; 33.1; 33.2 lies parallel to a plane E1, which has a component that is not equal to zero in the radial direction of the cylindrical axis, and which thereby suppresses the degree of freedom of movement solely in an axial direction of the cylinder 06; 07. Preferably, both pairs of interacting guide surfaces lie at the planes E1; E2, both of which have a component that is not equal to zero in the radial direction of the cylindrical axis, but in the reverse inclination have one component that is against the cylindrical axis, thereby suppressing the degree of freedom of movement in both axial directions of the cylinder 06; 07. A line of intersection of the two planes E1; E2 runs parallel to the direction of adjustment S.

If, as is shown in FIG. 6, the bearing block 34 is bordered between the two linear bearings 29, each of which has two pairs of interacting guide surfaces 32.1; 33.1 and 32.2; 33.2, and especially if that bearing block is prestressed with a level of pre-tension, then the bearing block 34 has only a single degree of freedom along the direction of adjustment S.

The inclined active or guide surfaces 32.1; 32.2; 33.1; 33.2 are positioned such that they counteract a relative movement of the bearing parts of the linear bearing 29 in an axial direction of the cylinder 06; 07, so that the bearing is “set” in an axial direction.

The linear bearings 29 of both of the bearing units 14, which are positioned at the end surfaces of a cylinder 06; 07, preferably have two pairs of interacting guide surfaces 32.1; 32.2; 33.1; 33.2 arranged in this manner in relation to one another. In this case, however, at least one of the two radial bearings 31 of the two bearing units 14 advantageously has a low bearing clearance Δ31 in an axial direction.

In FIGS. 6 and 8, the guide surfaces 32.1; 32.2 of the bearing elements 32, and that are fixed to the frame, point the linear guide 29 in the half-space that faces the journal 21; 22. In this case, the bearing elements 32 that are fixed to the frame wrap around the bearing block 34, which is arranged between them. The stationary guide surfaces 32.1; 32.2 of the two linear bearings 29 thus wrap partially around the guide surfaces 33.1; 33.2 of the bearing block 34 relative to an axial direction of the cylinder 06; 07.

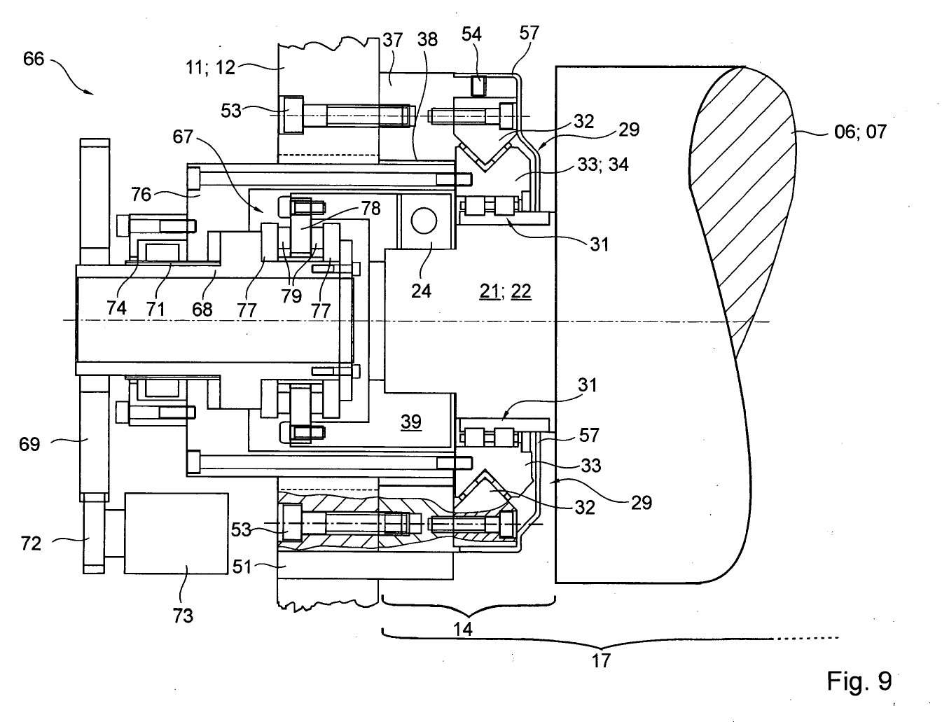

For the correct placement of the bearing units 14, or of the cylinder units 17, and including the bearing unit 14, mounting aids 51, such as, for example, alignment pins 51, can be provided in the side frame 11; 12, to which mounting pins 51 the bearing unit 14 of the fully assembled cylinder unit 17 is aligned before being connected to the side frame 11; 12, via the use of separable connecting elements 53, such as screws 53, as seen in FIG. 9, or even with an adhesive force via welding. For the adjustment of the bearing pre-stress in the linear bearings 29, which adjustment is to be performed prior to installation in the printing unit 01 and/or which is to be readjusted after installation, appropriate assemblies 54, such as, for example, adjustment screws 54, can be provided, as may be seen in FIG. 6. The bearing unit 14, at least toward the cylinder side, is preferably largely protected against contamination by a cover 57, or is even completely encapsulated as a structural unit.

In FIG. 6, the cylinder 06; 07 with the journal 21; 22, and a preassembled bearing unit 14 is schematically characterized. This component group can be easily installed, preassembled, between the side frames 11; 12 of the printing unit 01, and can be fastened at points which are designated for this purpose. Preferably, for a modular construction, the bearing units 14 for the forme cylinders 07 and for the transfer cylinders 06, optionally up to the permitted operational size of the adjustment path, have the same configuration. With the preassembled embodiment, the active inner surface of the radial bearing 31 and the active outer circumferential surface of the journal 21; 22 can both be cylindrical rather than conical in structure, as both the mounting of the bearing unit 14 on the journal 21; 22 and the adjustment of the bearing clearance can be performed outside of the printing unit 01. For example, the bearing unit 14 can be shrunk to fit.

The structural unit that can be mounted as a complete unit, such as bearing unit 14 is advantageously in the form of a housing that is optionally partially open from, for example, the support 37, and/or, for example, from a frame, in FIG. 7, for example, the four side supports 61; 62; 63; 64, for example side plates 61; 62; 63; 64 that border the bearing unit 14 toward the outside on all four sides, and/or, for example, from the cover 57, as seen in FIG. 6. The bearing block 34 having the radial bearing 31, the linear guides 29, and, in one advantageous embodiment, having, for example, the actuator 43 or the actuators 43 are accommodated inside this housing or this frame.

The bearing elements 32 that are fixed to the frame are arranged essentially parallel to one another and define a direction of adjustment S, which is depicted in FIG. 7.

An adjustment of the cylinders to a print-on position is accomplished by moving the bearing block 34 in the direction of the printing point 05 by the use of a force F that is applied to the bearing block 34 by at least one actuator 43, and especially by an actuator 43 that is power-controlled or that is defined by a force, and which can apply a defined or a definable force F to the bearing block 34 in the print-on direction to accomplish adjustment to the on position, as depicted in FIG. 7. The linear force at the nip points, which is decisive for ink transfer and thus for print quality, among other factors, is thus defined not by an adjustment path, but by the equilibrium of forces between the force F and the linear force F_{L} that results between the cylinders 06; 07, and the resulting equilibrium. In a first embodiment, which is not depicted separately, cylinders 06; 07 are engaged on one another in pairs, in that the bearing block 34 is acted upon by the correspondingly adjusted force F via the actuator or actuators 43. If multiple, such as, for example, three or four cylinders 06; 07 that are adjacent to one another in direct sequence, each acting in coordinating pairs, are configured without a possibility for fixing or for limiting the adjustment path S via a purely force-based adjustment mechanism, then although a system that has already been adjusted with respect to the necessary pressures, or linear forces, can be again correctly adjusted in sequence and in succession, it is possible to implement a basic adjustment only with difficulty, due to the somewhat overlapping reactions.

For adjusting the basic setting of a system, with corresponding packings and the like, it is thus provided, in one advantageous embodiment, that at least the two center cylinders of the four cylinders 06, in other words, at least all the cylinders 06 that differ from the two outer cylinders 07, can be fixed or at least limited in their travel, at least during a period of adjustment to a defined position, and advantageously to the position of engagement which is determined by the equilibrium of forces.

Particularly advantageous is an embodiment in which the bearing block 34, even during operation, is mounted such that it can move in at least one direction away from the printing point 05 against a force, such as, for example, against a spring force, and especially a definable force. With this, in contrast to mere travel limitation, on one hand a maximum linear force is defined by the coordination of the cylinders 06; 07, and on the other hand a yielding is enabled, for example in the case of a web tear which could be associated with a paper jam on the cylinder 06; 07.

The bearing unit 14, or one side that faces the printing point 05, at least during the adjustment process, has a movable stop 41, which limits the adjustment path up to the printing point 05. The stop 41 can be moved in such a way that a stop surface 44, that acts as the stop, can be varied in at least one area along the direction of adjustment. Thus, in one advantageous embodiment, an adjustment device, adjustable stop 41, is provided, by the use of which, the location of an end position of the bearing block 34, that is near the printing point, can be adjusted. For travel limitation/adjustment, for example, a wedge drive, which will be described below, is provided. In principle, the stop 41 can be adjusted manually or via the use of an adjustment element 46 which is implemented as an actuator 46. Further, in one advantageous embodiment, a holding or clamping element, which is not specifically illustrated in FIGS. 6 and 7, is provided, by the use of which, the stop 41 can be secured in the desired position. Further, at least one spring-force element 42, such as, for example, a spring element 42, is provided, which exerts a force F_{R} from the stop 41 on the bearing block 34 in a direction away from the stop. In other words, the spring element 42 effects an adjustment to the print-off position when the movement of the bearing block 34 is not impeded in some other way. An adjustment to the print-on position is accomplished by moving the bearing block 34 in the direction of the stop 41 via at least one actuator 43, and especially via a power-controlled actuator 43, by the use of which, a defined or a definable force F can optionally be applied to the bearing block 34 in the print-on direction, for the purpose of adjustment. If this force F is greater than the restoring force F_{R} of the spring elements 42, then, with a corresponding spatial configuration, an adjustment of the cylinder 06; 07 in relation to the adjacent cylinder 06; 07 and/or an adjustment of the bearing block 34 in relation to the stop 41 takes place.

In an ideal case, the applied force F, the restoring force F_{R} and the position of the stop 41 are selected such that between the stop 41 and the stop surface of the bearing block 34, in the adjusted position, no substantial force ΔF is transferred, and such that, for example, |ΔF|<0.1*(F−F_{R}), especially |ΔF|<0.05*(F−F_{R}), ideally |ΔF|=0. In this case, the adjustment force between the cylinders 06; 07 is essentially determined from the force F that is applied via the actuators 43. The linear force at the nip points, which is decisive for ink transfer and therefore for print quality, among other factors, is thus defined primarily not by an adjustment path, but, in the case of a quasi-free stop 41, by the force F and the resulting equilibrium. In principle, once the basic adjustment has been determined with the forces F necessary for this, a removal of the stop 41 or of a corresponding immobilization element, that is active only during the basic adjustment, would be conceivable.

In principle, the actuator 43 can be configured as any actuator 43 that will exert a defined force F. Advantageously, the actuator 43 is configured as a servo element 43 that can be actuated with pressure medium, especially as pistons 43 that can be moved by a fluid. In terms of potential tilting, the inclusion of multiple, in this case two, actuators 43 of this type is advantageous. The actuator or actuators 43 can either be integrated into the side supports 63 or into the carriages 34, or they can be arranged, as shown in FIG. 7, in a special structural component, such as an actuator element 59, and can be installed in the bearing unit 14. A liquid such as oil or water is preferably used as the actuating fluid, due to its incompressibility. In another embodiment, the actuator 43 can also be configured as a piezo element, for piezoelectric force application or as a magnet, for magnetic force application, and especially as an electromagnet.

To control the actuators 43, which are configured, in this case, as hydraulic pistons 43, a controllable valve 56 is provided either inside or outside of the bearing unit 14. Valve 56 valve is configured, for example, to be electronically actuatable, and places the hydraulic pistons 43 in one position that is pressureless or at least is at a low pressure level, while in another position the pressure P that conditions the force F is present. In addition, for safety purposes, a leakage line, which is not indicated here, is also provided.

To prevent on and off adjustment paths that are too large, while still protecting against web wrap-up, on a side of the bearing block 34 that is distant from the printing points, a travel limitation, by the use of a movable, force-limited stop 49 as an overload protection element 49, such as, for example, a spring element 49, can be provided, which spring element 49, in operational print-off, when the pistons 43 are disengaged and/or retracted, can serve as a stop 49 for the bearing block 34 in the print-off position. In the case of a web wrap-up or other excessive forces from the printing point 05, the stop 49 will yield and allow will thus a larger path. A spring force for this overload protection element 49 is therefore selected to be greater than the sum of forces from the spring elements 42. Thus, in operational on/off adjustment, only a very short adjustment path, of, for example, only 1 to 3 mm, can be provided.

In the represented embodiment, which is depicted in FIG. 7, the stop 41 is implemented as a wedge 41 that can be moved crosswise to the direction of adjustment S, wherein, in the movement of this wedge, the position of the respective effective stop surface 44, along the direction of adjustment S, varies. The wedge 41 is supported, for example, against a stop 58 that is stationarily fixed to the support. In this case, the stop 58 that is fixed to the support is formed, for example, by a side support 61 of the bearing unit 1.4.

The stop 41, which is configured here as a wedge 41, can be moved by an actuator 46, such as, for example, by a servo element 46 that can be actuated with pressure medium, such as a piston 46 that is actuatable with pressure medium, in a working cylinder with dual-action pistons, via a transfer element 47, which may be configured, for example, as a piston rod 47, or by an electric motor via a transfer element 47, which may be configured as a threaded spindle. This actuator 46 can either be active in both directions, or, as illustrated here, can be configured as a one-way actuator, which, when activated, works against a restoring spring 48. For the aforementioned reasons, largely powerless stop 41, the force of the restoring spring 48 is selected to be weak enough that the wedge 41 is held in its correct position against only the force of gravity or vibration forces.

In principle, the stop 41 can also be implemented in another manner, such as, for example, as a ram that can be adjusted and which can be secured in the direction of adjustment, such that it forms a stop surface 44 for the movement of the bearing block 34 in the direction of the printing point 05 that is variable in the direction of adjustment S and, at least during the adjustment process, can be fixed in place. In an embodiment which is not specifically illustrated here, an adjustment of the stop 41 is implemented, for example, directly parallel to the direction of adjustment S, via a drive element, such as, for example, a cylinder that is actuatable with pressure medium, with dual-action pistons or with an electric motor.

In FIG. 2, on the printing group 03, which is configured as a blanket-to-blanket printing unit 03, one bearing unit 14 is schematically indicated, arranged on the side frame 11 for each cylinder 06; 07. In one advantageous embodiment illustrated here, in the print-on position, the rotational centers of the cylinders 06; 07 form an imaginary line or a plane of connection E, hereinafter referred to as the “linear blanket-to-blanket printing unit”. The plane E, and the entering and exiting web 02, preferably form an interior angle that deviates from 90 degrees, measuring between 75 degrees and 88 degrees, and especially between 80 and 86 degrees. When the embodiment which is depicted in FIG. 2 is in its mounted state, the bearing unit 14 of the transfer cylinder 06, and especially of all of the cylinders 06; 07, are arranged on the side frame 11 in such a way that their directions of adjustment S, for example, for the purpose of a force-defined print-on adjustment, form a maximum angle of 15 degrees with the plane of connection E, for example an acute angle of approximately 2 degrees to 15 degrees, especially 4 degrees to 10 degrees, with one another. This arrangement is of particular advantage, with respect to mounting, if the direction of adjustment S extends horizontally and the web 02 extends essentially vertically.

In a modified embodiment, as depicted in FIG. 1, of an angular blanket-to-blanket printing unit 03, n or u printing unit, the plane E′ is understood as the plane of connection for the cylinders 06 that form the printing points 05, and the plane E″ is understood as the plane of connection between the forme and transfer cylinders 07; 06, of a respective printing group or couple 04, and what is described above in reference to the angle is referred to the direction of adjustment S for at least one of the cylinders 06 that form the printing points 05, or the forme cylinders 07, and the planes E′ or E″.

One of the cylinders 06 that form the printing points 05 can also be arranged in the side frame 11; 12 such that it is stationary and functionally non-adjustable, but is optionally adjustable, while the other is mounted such that it is movable along the direction of adjustment S.

An operational adjustment path, for adjustment to the on/off positions, along the direction of adjustment S between the print-off and print-on positions, for example in the case of the transfer cylinder 06, measures between 0.5 and 3 mm, especially measures between 0.5 and 1.5 mm, and in the case of the forme cylinder 07, measures between 1 and 5 mm, and especially measures between 1 and 3 mm.

In the embodiment of the printing unit 01 as a linear blanket-to-blanket printing group 03, the plane E is inclined from the planes of the incoming and outgoing web 02 for example, at an angle measuring 75 degrees to 88 degrees or 92 degrees to 105 degrees, preferably an angle measuring 80 degrees to 86 degrees or 96 degrees to 100 degrees, in each case on one side of the web or 96 degrees to 100 degrees or a 80 degrees to 86 degrees on the respective other side of the web.

In another embodiment, which is not shown here, the bearing units 14 of the transfer cylinder 06, and especially of all cylinders 06; 07, are arranged in the mounted state on the side frame 11 in such a way that their directions of adjustment S coincide with the plane of connection E. Thus, all the directions of adjustment S of the printing group 04 coincide, and are not spaced from one another.

In one variation, the actuator 43 can also be arranged as being integrated into the bearing block 34, and butting up against the side plate 63. In a further variation, at least one additional actuator, which, when activated, acts away from the printing point 05, can also be provided. That actuator can replace or can support the spring element 42.

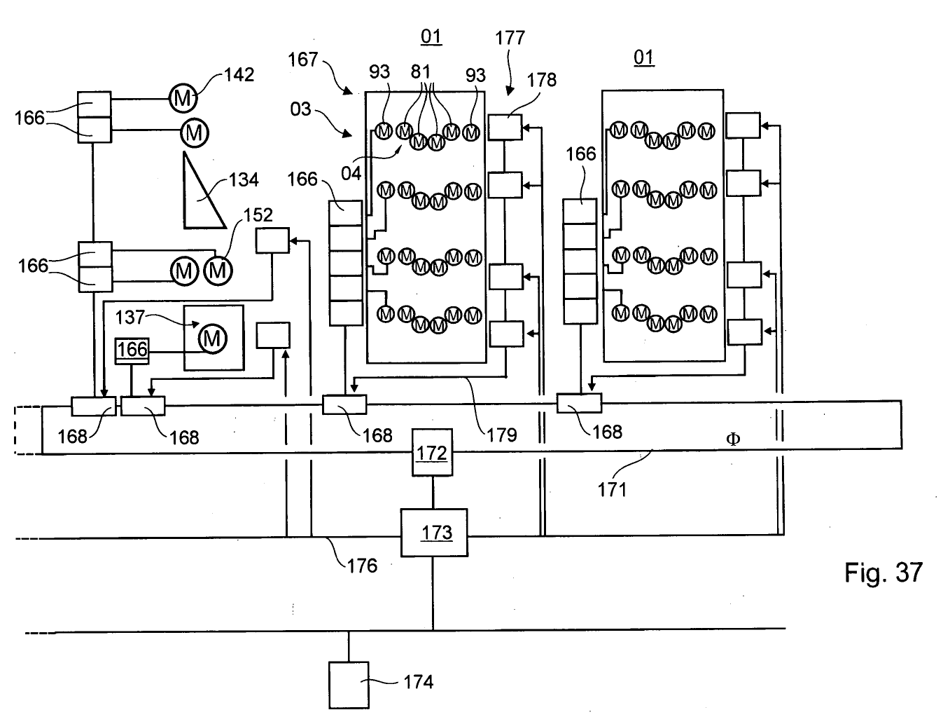

FIG. 9 shows a preferred embodiment of the coupling of an axial drive unit for lateral register adjustment, which is located, for example, on the side of the cylinder 06; 07 that is opposite the drive side, and especially for the cylinder 07 that is configured as a forme cylinder 07. To this end, the cylinder journal 21 is preferably coupled with a device for moving the cylinder 07 axially, such as a lateral register drive unit 66, for example a drive motor 66, as depicted in FIG. 37. The shaft 39, which is attached to the journal 21, for example in the manner illustrated in FIG. 9, is connected via a bearing 67, for example via an axial bearing 67, to an axial drive unit 68, 69, 72, 73. The axial drive unit 68, 69, 72, 73 comprises a spindle 68, especially with at least one threaded section 71, a spur gear 69 that is connected torsion-proof to the spindle 68, a pinion gear 72, and a motor 73 that drives the pinion gear 72. The threaded section 71 acts in coordination with internal threading 74 that is fixed on the bearing block, for example internal threading 74 on a cup 76 that is connected to the bearing block 34, and, with the rotation of the spindle 68, effects axial movement of the threaded section 71, along with the shaft 39, via the axial bearing 67 and the journal 21. The axial bearing 67 permits relative rotation between the shaft 39 and the spindle 68, but is configured to be rigid to compression and tension in an axial direction of the cylinder 07. This is accomplished by the provision of a disk 78 which is arranged on the shaft 39, which is mounted on both sides, for example via rolling elements 79, and is limited in its travel in both directions by stops 77 that are fixed to the spindle. An adjustment of the lateral register is accomplished with the motor 73, via a control device that is not illustrated in FIG. 9. In this arrangement, either the motor 73 can be equipped with a position reset indicator internal to the motor, which for example, has been appropriately calibrated beforehand, or a position reset message can be sent to the control unit by a sensor that is not specifically illustrated here, for example by a correspondingly calibrated rotary potentiometer, which is coupled to a rotational component of the axial drive.

Regardless of the special configuration of the bearing and/or the alignment of the adjustment path to the plane E or E′ or E″, with either a slight inclination or no inclination, and/or the separability of the printing unit 01 and/or the coupling of an axial drive unit, in the discussion which follows particularly advantageous embodiments for the coupling of a drive motor 66 to the rotational component configured here as a cylinder 06; 07 and/or especially advantageous embodiments of the drive motor 66 that drives the rotational component will be specified.

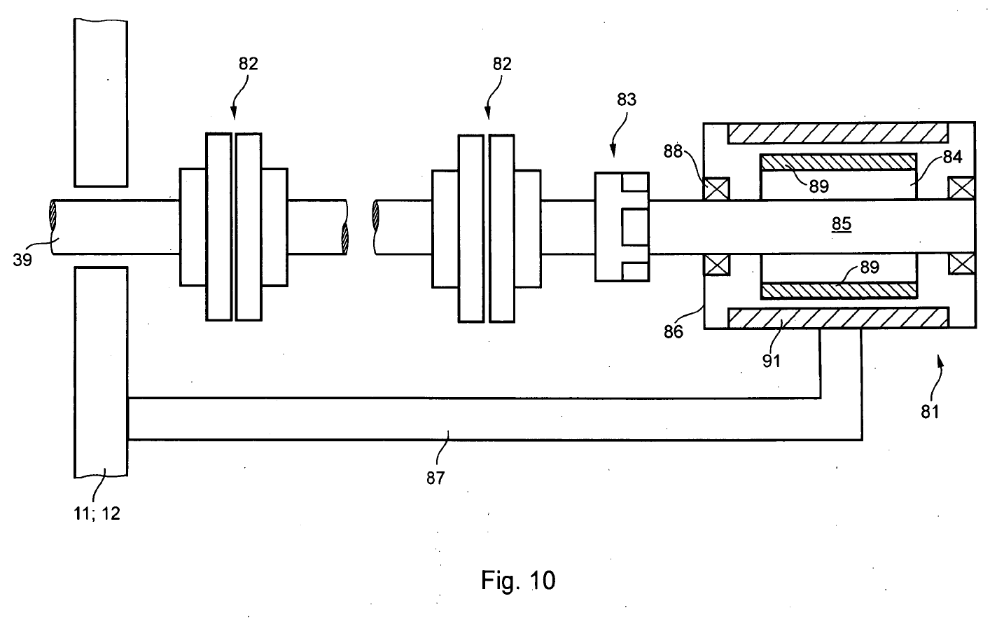

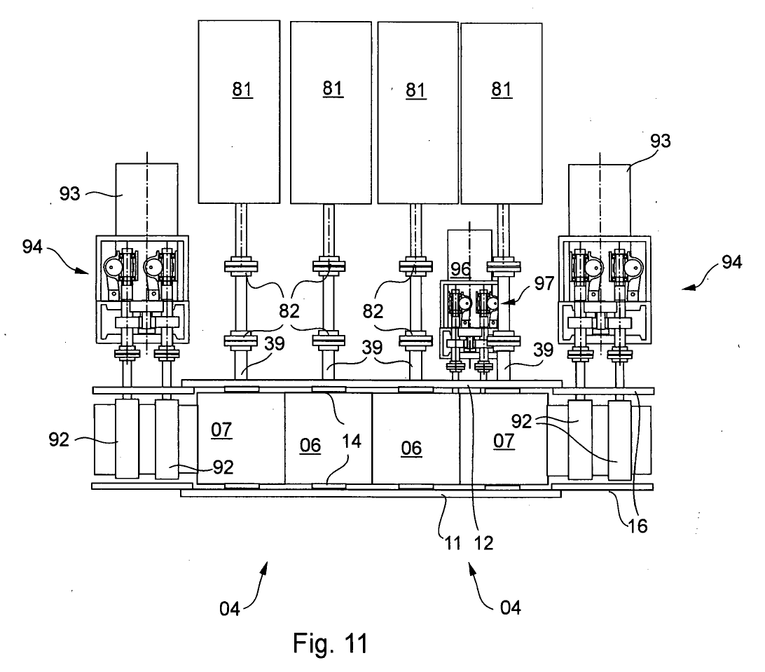

In an example of the drive coupling that is not a part of the invention, as represented in FIG. 6, and taken in connection with FIG. 10 or 11, the cylinder 06; 07 or the journal 21; 22 is coupled on a drive side of the printing unit 01 to a drive unit, such as, for example, by being coupled directly to a rotor of a drive motor 81 and/or a drive train, via at least one coupling 82 which is structured to compensate for angle and/or offset. The drive motor 81, and especially its rotor, can then be fixed to the frame, and need not follow the cylinder in its on/off adjustment movement.

In this first embodiment of the drive unit for the cylinder 06; 07, or for another rotating component the drive motor 81 to be coupled is preferably configured as a synchronous motor 81 and/or as a permanent magnet electric motor and especially as a permanent magnet synchronous motor 81. This drive motor 81 is a directly driven round motor and has a stator with three-phase winding, and with a rotor with permanent magnets. With this configuration of the drive motor 81, and especially with the permanent magnets, a high power density is achieved, making the use of gear transmission systems unnecessary. Inaccuracies in the drive train, and wear and tear on mechanical elements and transmission systems are thereby eliminated.

The coupling of the rotary drive unit to the rotating component, in this case to the cylinder 06; 07, is accomplished, in this case, as is shown by way of example for the first embodiment in FIG. 6, via the shaft 39, which, at its cylinder end, encompasses one end of the journal 21; 22 and is connected torsion-proof to the journal 21; 22, for example, via a clamping device 24. The clamping device 24 is configured here, for example, as a partially slotted, hollow shaft end, which encompasses the journal end, such as journal 21; 22, and which can be tightened by the use of a screw connection, such that a non-positive, torsion-proof connection can be created between the journal end, such as journal 21; 22, and the interior surface of the hollow shaft.

The coupling can also be configured differently, for example having a form closure in a circumferential direction. In one advantageous variation, it is also possible to form the torsion-proof, non-positive connection using tension clamping elements. The shaft 39 is fed through an opening in the side frame 11; 12, which opening is large enough to permit the shaft 39 to move together with the bearing block 34 and which is configured as, for example, an elongated hole. To protect against contamination, a cover 28, with a collar that overlaps the elongated hole, can be provided, which cover 28 is connected, for example, to the bearing block 34, but not to the shaft 39.

At the end of the shaft 39 that is distant from the cylinder, as shown in FIG. 6, one of optionally a plurality of couplings 82 arranged in series, which are configured to compensate for angle and/or offset, especially a multi-disk coupling 82, can be coupled, by the use of a torsion-proof connection 36, for example a clamping element 36.

In FIG. 10, which, in terms of the drive coupling is not a part of the invention, a drive motor 81, which is configured as a permanent magnet drive motor 81, and especially as a synchronous motor 81, is represented, the rotor 84 of which is coupled to the shaft 39, for example, via a motor shaft 85, which supports the rotor 84 in a torsion-proof fashion, and via an additional torsion-proof coupling 83, such as, for example, a square-tooth coupling 83. The stator 86 of the drive motor 81 is connected torsion-proof to the side frame 11; 12 via a bracket 87. The rotor 84 is mounted in the stator 86 on bearings 88, especially on radial bearings 88, and is optionally secured against axial motion. Axial motion, in the case of the cylinder 07 configured as a forme cylinder 07, is supported by the couplings 82. The rotor 84 or the rotating element of the synchronous motor 81 has poles in the form of permanent magnets 89 on its outer circumference, and especially poles which are alternating in the circumferential direction. The stator 86 has windings 91 that are positioned opposite the permanent magnets 89 for the purpose of generating magnetic fields through electrical energy.

The drive motor, such as, for example, drive motor 81, configured as a permanent magnet synchronous motor 81 is configured, for example, as a field-suppressing synchronous motor. The field suppression of the synchronous motor is provided, for example, at a ratio of 1:10.

Drive motor 81 has at least six pairs of poles, and advantageously has at least 12 pairs of poles. The permanent magnets 89 preferably contain rare-earth materials. Especially advantageous is the construction of the permanent magnets 89 using neodymium-iron-boron.

The drive motor, such as, for example, the drive motor 81, configured as a permanent magnet synchronous motor 81, has, for example, a continuous stalled torque in the range of 50 nm to 200 nm, especially from 50 to 150 nm for driving printing group cylinders 06; 07, or from 100 to 200 nm for driving reel changers or folding units. Advantageously, the drive motor, such as, for example, the drive motor 81, which is configured as a permanent magnet synchronous motor 81, has a maximum torque of 200 to 800 nm, 200 to 400 nm for driving printing group cylinders 06; 07, or 600 to 800 nm for driving reel changers or folding units.

The drive motor, such as, for example, the drive motor 81, which is configured as a synchronous motor 81 and/or as a permanently energized motor 81 has, for example, a theoretical idle running speed of 500 rpm to 600 rpm.

A frequency transformer for use in regulating speed, is connected upstream from the drive motor, such as, for example drive motor 81, that is configured as a synchronous motor 81 and/or as a permanently energized motor. The stator 86 is advantageously configured with a 3-phase winding, wherein sinusoidal commutation of the current occurs.

On the drive motor, such as, for example, the drive motor 81, which is configured as a synchronous motor 81 and/or as a permanently energized motor, a sensor 106, specified below, for example a torque angle sensor 106, is preferably provided. A rotational axis of the torque angle sensor 106 can advantageously be arranged coaxially in relation to the rotational axis of the rotor 84 of the motor, such as, for example, the drive motor 81.

A cooling device, and especially a fan propeller or a liquid coolant circuit, is advantageously provided on the drive motor, such as, for example, the drive motor 81, which is configured as a synchronous motor 81 and/or as a permanently energized motor.

In addition, a braking device can be provided on the motor, such as, for example, the drive motor 81, which is configured as a synchronous motor 81 and/or as a permanently energized motor. However, the motor can also be used in generator mode as a braking device.

Further, fitting mechanisms can be provided for proper positioning of the stator 86 and the rotor 84 in relation to one another.

The above discussions regarding the configuration of the permanently energized synchronous motor 81 can be applied, in full, or in part, to corresponding drive motors 138; 139; 140; 141; 142; 143; 152; 162; 163, as will be discussed below for rotating components 133; 135; 136; 144; 145; 146; 147; 148; 153; 164, as will also be discussed below, other than printing group cylinders 06; 07.

As shown in FIG. 11, which with respect to the drive coupling is not a part of the present invention, in one advantageous embodiment, each of the printing group cylinders 06; 07 is driven independently by a drive motor 81. The offset which is necessary for on/off adjustment of the nip points is enabled in this case by the couplings 82.

In the embodiment which is shown in FIG. 11, an inking unit transmission with its own drive motor, usable for rotation and for oscillating motion, and, in the case of wet offset printing, a dampening unit transmission with its own drive motor, also usable for rotation and oscillating motion, provide variability and precision.

By way of example, in FIG. 11, the drive unit for the printing group 04 is shown on the left side for the circumstances of dry offset printing, without a dampening unit, and on the right side for the circumstances of wet offset printing, with a dampening unit. Of course, the two printing groups 04 of an actual blanket-to-blanket printing group 03 would be of the same type. In the end surface view, for purposes of clarity, the roller layout has been omitted and only the drive trains with motors are shown. In the plan view, the drive layout is represented using the example of an inking unit 08 with two rotationally actuated oscillating rollers 92, such as, for example, distribution cylinders 92, and, in the case of wet offset printing, using the example of a dampening unit 09 with a rotationally actuated distribution cylinder that is not shown.

Each inking unit 08 has its own drive motor 93 for rotational actuation, which drive motor 93 is mechanically independent from the printing group cylinders 06; 07. With these drive motors 93, especially the two distribution cylinders 92 of the inking unit 08 are rotationally actuated, for example via a transmission 94 that is not specified in greater detail here. In the case of wet offset printing, depicted at the right, essentially the same applies to the actuation of the dampening unit 09 with a drive motor 96 and with a transmission 97. For each distribution cylinder 92 of the inking unit 08 and for each distribution cylinder of the dampening unit 09, frictional gearing that generates the axial oscillating motion can be provided. However, in principle, that gearing can be actuated by an additional drive motor, or as represented in FIG. 11, can be configured as a transmission that converts the rotational motion into axial motion.

In FIG. 11, in an advantageous configuration, the bearings are shown as bearing units 14 in the aforementioned embodiment for the mounting of the four cylinders 06; 07. The shafts 39 are guided, for example, through corresponding recesses or openings in the side frame 11; 12.

The coupling between the stationary drive motor 81 and the forme cylinder 07, which is not a part of the invention, is preferably configured to enable a lateral register control/regulation such that it will also support axial relative motion between the forme cylinder 07 and the drive motor 81. This can also be accomplished via the aforementioned multi-disk coupling 82, which permits an axial length adjustment. An axial drive unit, configured as is shown in FIG. 9 or possibly configured differently, can be provided on the other side of the frame from the rotary drive unit.

The actuated distribution cylinders 92 of the inking unit 08 can also be coupled to the drive motor 93 via at least one coupling which compensates for angular deviation.

The drive motors 93 in the inking unit 08 and/or in the dampening unit 09 can be structured in the manner of the above-described permanent magnet drive motors 93, and especially as the synchronous motor 93. However, dimensioning and configuration may differ from the aforementioned, if applicable.

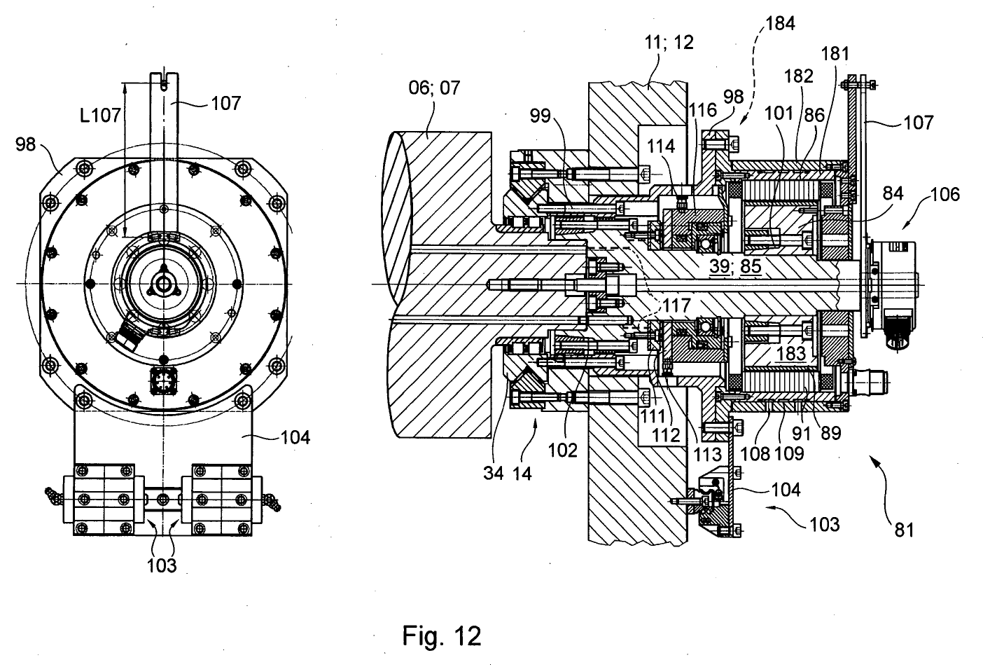

In a preferred embodiment of the drive coupling, as shown in FIG. 12 the rotating component, for example the cylinder 06; 07, is coupled to the drive motor 81 directly, without a coupling that will enable relative axial motion and/or without a coupling that will compensate for angle or offset via the drive shaft 39. This coupling can be rigid, but detachable in configuration. In this embodiment, the drive motor 81, for example, is not stationary. Rather, it is arranged fixed to the cylinder and is moved along with the cylinder 06; 07 during on/off adjustment, and, if applicable, also during lateral register displacement. In the case of cylinders 06; 07 that can be moved via a bearing assembly 14, the drive motors 81 of each printing group cylinder 06; 07 are rigidly connected, not to the side frame 11; 12, but directly to the movable bearing block 34, for example with screws, and are moved along with it during adjustment.

FIG. 12 shows a configuration of the drive unit of a rotating component, especially of the cylinder 06; 07, that is mounted on the bearing unit 14, with a drive motor 81 that is configured as a synchronous motor 81 and/or as a permanently energized motor, or is configured with a section of permanent magnets 89 on the rotor 84.

In this configuration, the stator 86 is rigidly fastened, for example, either directly or indirectly, to the movable part of the bearing unit 14, such as, for example, to the movable bearing block 34, and can be moved together with it. In the case of a different type of bearing assembly 14, the stator 86 is mounted, for example, on the interior eccentric bushing or on the lever. In FIG. 12, the parts that relate to the bearing unit 14 are not identified again with reference symbols and may be taken from FIG. 6. In the example shown in FIG. 12, the stator 86 with the windings 91 is detachably screwed to a clamping element 98, such as, for example, a bushing 98, and especially a collar bushing 98, which is detachably connected, for example via screws 99, to the bearing block 34.

In the present embodiment shown in FIG. 12, the motor shaft 85 of the drive motor 81, which supports the permanent magnets 89 and/or the rotor 84, is formed by the shaft 39, or conversely the shaft 39 is formed by the motor shaft 85. Motor shaft 85 and rotor 84 can also be configured as a single part, in which case the motor shaft 85 bears the permanent magnets 89 around its periphery. In this example, motor shaft 85 and rotor 84 are configured as two components, and are connected torsion-proof to one another via a clamping element 101 or via a clamping ring 101.

The torsion-proof connection between the shaft 39 or the motor shaft 85 and the journals 21; 22 is formed in this case, by a frictional connection, such as, for example, by a clamping element 102 or by a clamping ring 102.

As a result, rotor 84 and cylinder 06; 07, or the cylinder journal 21; 22 are connected to one another, rigidly and torsion-proof in an axial direction and in a radial direction. However, the connection can be detachable, in configuration, at various points. Thus, the rotor 84 moves along when the cylinder 06; 07, and especially when the forme cylinder 07, is moved axially or radially. The stator 86 is arranged, fixed to the cylinder, with respect to movement perpendicular to the longitudinal cylinder axis, and moves along with it during on/off adjustment.

In contrast to the embodiment of the drive motor 81, as depicted in FIG. 10, in this case, as depicted in FIG. 12, preferably no radial bearings 88 are positioned between the stator 86 and rotor 84 for mutual support.

For additional support and/or for additional security against torsion of the, in this case permanently energized synchronous motor 81, and especially of its stator 86, a guide 103 can be provided, on which guide 103 the motor slides. The guide 103 conforms to the curvature of the adjustment path of the bearing assembly 14, and thus has “similarity” to the adjustment path, and, in this case, is configured as a linear guide 103. Additionally, a stationary part of the guide 103 is connected to the side frame 11; 12, and the stator 86 is connected to the corresponding movable part of the guide 103, such as, for example, via a support 104, such as a support plate 104. The degree of freedom of the linear guide 103 needs to be only a few millimeters. In the represented embodiment, however, the support and/or an anti-rotation element may be omitted if the bearing assembly 14, and especially if the linear bearing 29, is sufficiently rigid and strong in configuration to accommodate both the torque between the stator 86 and the rotor 84, and the tilting moment caused by the weight of the stator 86, with bushing 98, and the like.

In the preferred embodiment of the drive motor 81, and especially as a drive unit for rotating components that require register retention in a circumferential direction, as represented by printing group cylinders 06; 07 or for cylinders of a folding unit, as will be discussed below, the drive motor 81 is configured as an angular position-controlled drive motor 81. For control or angular position control, a sensor 106 that is connected, in a torsion-proof manner, to the component, such as cylinder 06; 07 or to the drive motor 81, such as, for example, a sensor 106 that detects the angular position, and especially configured as an angular position sensor 106, is necessary, via which sensor 106 the actual angular position is transmitted back to the control circuit. In the case of a component that does not require register retention, such as, for example, an inking unit 08, an infeed unit or a drawing roller, but which does require a presettable speed, the sensor 106 can also be configured as a sensor 106 that detects only the speed, and especially can be configured as a speed sensor. In the case of a cylinder 06; 07, as shown in FIG. 12, the sensor 106 can, in principle, be arranged on any component that is connected in a torsion-proof manner to the cylinder 06; 07, such as, for example, even on the journal 21; 22 that lies opposite the drive motor 81. In the advantageous embodiment which is represented, however, the sensor 106, and especially its rotor, is arranged coaxially to the axis of cylinder rotation, at the end of the motor shaft 85 that is distant from the cylinder. The stator of the sensor 106 is secured, against torsion, by an anti-rotation element 107 on the stator 86 of the drive motor 81. The anti-rotation element 107 has a degree of freedom, in a radial direction, to allow the stator of the sensor 106 to follow a potentially untrue path of the motor shaft 85 and thereby of the sensor rotor. In this, the anti-rotation element 107 is secured, for example, by the provision of an elongated opening that extends radially, and into which a pin engages. In order to minimize angular errors resulting from an untrue path, the anti-rotation element 107 is configured as a lever that is long in the radial direction. The length L107 of the lever 107 from the sensor stator to the fixed point of the anti-rotation element 107 corresponds, for example, to at least an outer diameter, and advantageously corresponds to at least twice the outer diameter, of the sensor rotor, in order to minimize the angle of an oscillating motion that may occur in the event of an imbalance.

In one advantageous embodiment, the drive motor 81 has a cooling system, even if rotating components of the printing machine other than printing group cylinders 06; 07 are used. In a simple embodiment, which is not specifically shown here, cooling is achieved by the use of a fan propeller. Advantageously, however, a liquid coolant circuit is provided, in which circuit temperature-controlled coolant, such as water, can be fed through the drive motor 81. In FIG. 12, connecting bore holes 108 are provided in the housing of the stator 86, through which the coolant can be fed in coolant channels 109 between the housing and a support that bears the windings 91.

In the embodiment, which has been specified thus far in reference to FIG. 12, the drive motor 81, along with its linkage and peripheral components, including sensor 106 and/or cooling system and/or anti-rotation element 107, can be provided for both the cylinder 07 which is configured as a forme cylinder 07 and for the cylinder 06 which is configured as a transfer cylinder 06. In a special embodiment of the cylinder 06; 07, and especially of the forme cylinder 07, that cylinder, however, has clamping and/or release elements for fastening rubber packings, such as, for example, printing formes, and especially ends of individual printing plates, which are configured to be actuatable via pressurized medium. Preferably, the clamping and/or releasing elements are configured to be self-locking, so that clamping is effected without pressure-medium actuation, and opening or releasing is effected by applying pressure medium.

The cylinder 07 has a plurality of clamping and/or releasing elements, such as, for example, four or even six such elements, for example, in an axial direction, which elements can be actuated separately for fastening or releasing the same number of printing formes, such as, for example, printing plates, which are arranged side by side. In the case of separate printing plates, the ends of the printing plates are inserted into slits on the circumferential surface of the cylinder and are held in place by the clamping elements that are actuated via pressure medium, preferably in a self-locking fashion. In the configuration involving continuous printing formes, for example printing forme sleeves, outlet openings for the pressure medium are provided, for example, on the circumferential surface of the cylinder, wherein the printing formes that encompass the cylinder are released, for example, by impingement with such a pressure medium.

The cylinder 07 can have a plurality of clamping and/or releasing elements, for example two such elements, which may be arranged in tandem in a circumferential direction, which can be actuated independently of one another for fastening or for releasing the same number of printing formes, for example printing plates, arranged in tandem in a circumferential direction. Therefore, for example, a total of two groups can be arranged on the cylinder 07 for every four or six printing plates. The printing plates are changed in groups, however, so that when the cylinder is in a certain position, in any case, the clamping elements for a group of printing plates, for example four or six such elements, must be actuatable.

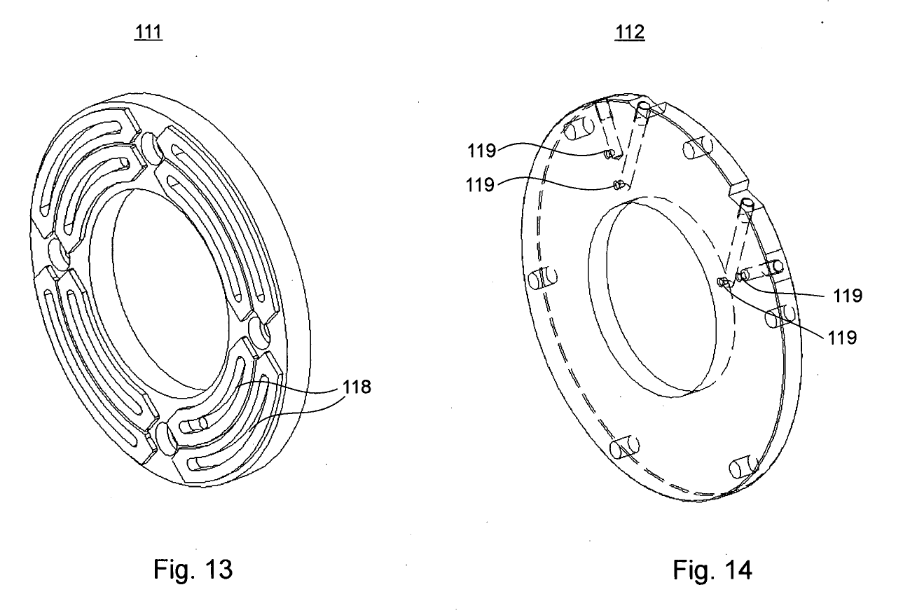

To accomplish the defined supply of the plurality of clamping elements in the cylinder 07 with a pressure medium, the drive train has a rotary transformer, through which a plurality of supply channels in the cylinder 07 can optionally be impinged with pressure medium, each independently of one another. In one advantageous embodiment, the rotating union is configured with an interface between the rotating and the torsion-proof components, to which interface the flow of pressure medium to be transmitted runs in an axial direction. A rotor 111, which is configured in the manner of a circular ring, is connected, torsion-proof, to the cylinder 07 or to its journal 21; 22, and has through holes 118 that extend axially through the rotor 111, as seen in FIG. 13. The through holes 118 are connected to lines 117, shown in dashed lines, that lead to the individual clamping elements. The number of through holes 118 that are spatially separated from one another on the rotor 111 corresponds to at least the total number of clamping elements to be actuated independently of one another. The rotor 111 interacts on an axially oriented, end-face contact surface with an opposite axially oriented end-face contact surface of a torsion-proof stator 112, shown in FIG. 14, which stator 112 has outlet openings 119 in its end-face contact surface such that these outlet openings 119 can optionally be placed in coverage with an intake opening of a through hole 118, depending upon the relative angular position between stator 112 and rotor 111, or optionally in coverage with intake openings of different through holes 119 based upon position. The number of outlet openings 119 corresponds to at least the number of clamping elements or printing plates in a group of printing plates which are arranged side by side on the forme cylinder 07, in this case, for example, four. These four outlet openings 119 are fed, for example, via four feeds 113 from lines that are separate from one another and are not shown specifically here, each of which lines can optionally be pressurized. In order to seal the interface in the selected relative position of the cylinder 07 during impingement, in one advantageous embodiment, stator 112 and rotor 111 are configured to be moved in relation to one another and are pressed against one another. In the present embodiment, the stator 112 is mounted on the shaft 39 so as to be axially movable, and it can be pressed against the rotor 111 by the operation of an annular ram 116. Pressure is accomplished, for example, by the impingement of an annular intermediate space with a pressure medium, which can be supplied via a suitable connection 114.

In one embodiment of the cylinder 06; 07, for example as a transfer cylinder 06, and without the requirement of a pressure medium supply, the rotary transformer with the above-described components can be omitted. If applicable, the drive motor 81 can also be installed closer to the cylinder 06; 07.

In a variation of the second embodiment, as shown in FIG. 12, and which is not part of the invention, the stator 86 is not rigidly connected to the bearing block 34. Rather, it is supported on the motor shaft 85 via radial bearings 88 in a manner comparable to what is depicted in FIG. 10. In this case, at least one anti-rotation element 103, 104, such as, for example, configured in the manner shown in FIG. 12, is necessary. The anti-rotation element can be configured to be rigid in the axial direction of the cylinder 06; 07 if the radial bearings 88 between rotor 84 or motor shaft 85 and stator 86 permit axial relative movement. In this case, the rotor 84 moves axially in the stationary stator 86 when the cylinder 06; 07 is moved axially.

If, however, the rotor 84 or motor shaft 85 and the stator 86 are both secured against axial relative movement, then the device for preventing rotation 103, 104 must also be configured to enable a degree of freedom in an axial direction of the cylinder 06; 07. In this case, the rotor 84 moves axially, together with the stator 86, when the cylinder 06; 07 is moved axially. Because this movement involves only a few millimeters, it can be accomplished in a simple embodiment, such as, for example, with a long lever arm, such as with a support 104 that is long in relation to the distance to the guide 103. The short axial movement is supported by a deformation of the support 104. In a second embodiment, either the guide 103 or the linkage of the support 104 to the stator 86 can have a further linear guide, but with a degree of freedom in an axial direction of the cylinder 06; 07. This can be implemented, for example, with pins, located for example on the side frame 11; 12, on the movable part of the guide 103 or on the stator 86, and with a corresponding through hole or eyelet situated on the corresponding component, such as, for example, on the stationary part of the guide 103, on the support 104 in the area of the guide 103 or on the support 104 in the area of the stator 86.

In the embodiment which is represented in FIG. 12, a part 181 of the stator 86 that supports the windings 91 is connected rigidly and torsion-proof in an axial direction, but detachably, such as, for example, via screw connections, which are represented but not specifically identified in FIG. 12, to the movable part of the bearing assembly 14 and, for example, to a housing 182 of the drive motor 81. This rigid connection 184, which is indicated in FIG. 12 as a unit by a dashed-line arrow, represents a connection that is rigid especially in an axial direction, and for non-movable cylinders, which can also be configured as rigid in a radial direction with respect to the side frame 11; 12. A part 183 of the rotor 84 that supports the permanent magnets 89 is connected to the cylinder 06; 07 so as to be rigid to axial relative movement, so that, with an axial movement of the cylinder 06; 07, such as, for example, to adjust the lateral register, axial relative movement between the windings 91 and permanent magnets 89 can necessarily occur.

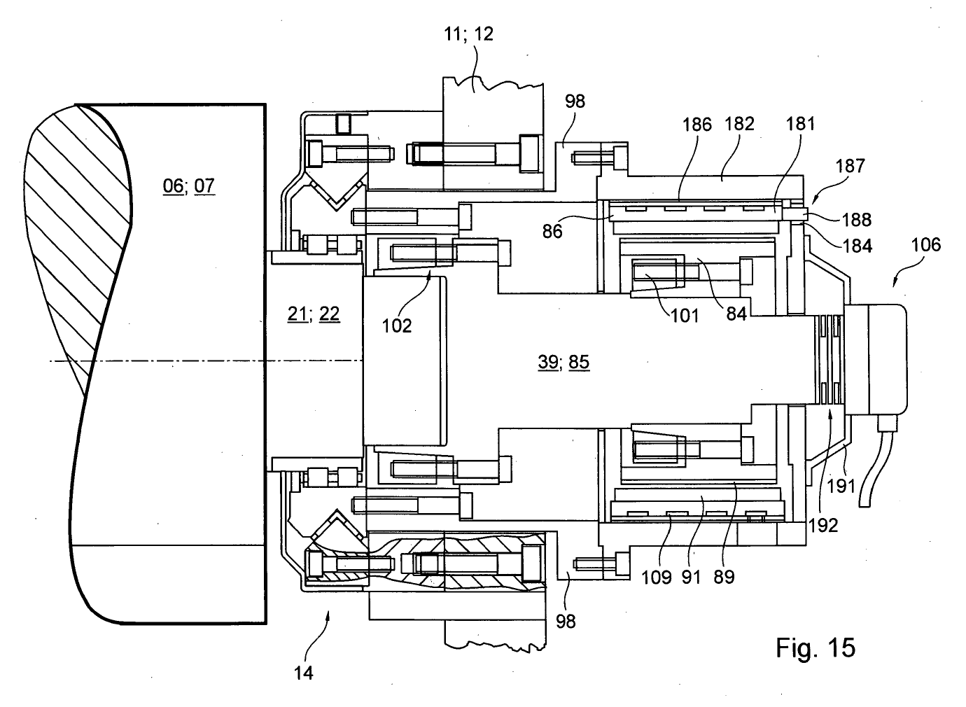

In the discussion which follows, and with reference to FIG. 15 through FIG. 18, particularly advantageous variations of the drive motor 81 are represented, which variations, in terms of axial positioning, ensure an optimal operating position between stator 86 and rotor 84 in relation to one another. FIGS. 15 through 18 are represented in simplified form, as compared with the more detailed depiction of FIG. 12, and can also have a rotary transformer, as described above and/or an above-described support and/or an anti-rotation element for the drive motor 81.

In an embodiment of the drive motor 81 that is not a part of the invention, although the stator 86 is secured against torsion, it is not fixed to the frame or the bearing in an axial direction. Rather, it is arranged so as to be axially movable, at least to a certain degree, for accomplishment of the lateral register. Relative to the side frame 11; 12 and/or to a part of a bearing assembly 14 that is capable of moving for the purpose of on/off adjustment, however, it is configured to be secured against any torsion that may occur. A coupling between stator 86 and rotor 84, as far as axial movement is concerned, is accomplished, in this case, not mechanically, but rather, for example, via magnetic forces. Now if, for example, a rotor, that is capable of moving axially along with the cylinder 06; 07, is moved in such an axial direction, the stator can be at least partially moved along with that rotor by virtue of their magnetic interaction. Ideally, the stator can be moved along with the rotor axially in such a way that the magnets of the stator and of the rotor can remain in the optimal operating position in relation to one another. The stator can remain stationary relative to the rotor, viewed in the extreme case.

The axial degree of freedom of the stator 86, with respect to the side frame 11; 12 and/or with respect to the bearing assembly 14, and including the torsion-proof connection with the side frame 11; 12 and/or the bearing assembly 14 on the other side, via an anti-rotation element, can be achieved in the widest variety of ways. Without the limitation of generalization, in FIGS. 15, 16 and 17 three first advantageous embodiments are represented. In these three embodiments, between stator windings and side frame 11; 12 and/or bearing assembly 14 or clamping element 98, the connection is not rigid in an axial direction. Rather, within certain limits, such as, for example, an axial relative movement in the range of at least 1 mm, i.e. at least ±0.5 mm, viewed from a center position, the connection is “soft” in an axial direction.

In contrast to the depiction in FIG. 12, in FIG. 15, which is not part of the invention, there is no rigid connection, as at 184, between the stator 86, or the part that supports the windings 91, and the housing 182. The part of the stator 181 that supports the windings 91 is mounted so as to be axially movable in the housing 182. To this end, the housing 182, and the part of the stator 181 that supports the windings 91, are configured, for example, with interacting sliding surfaces 186. The assurance of the maintained relative radial position, with the simultaneous enabling of relative axial movement, can also be accomplished, in principle, in a manner other than with a sliding guide which is equipped with sliding surfaces 186. In this embodiment, the housing 182, as is depicted in FIG. 12, is connected, rigid to compression and tension and torsion-proof, to the clamping element 98, i.e. ultimately to the bearing assembly 14, and/or to the side frame 11; 12. However, to insure that the motor torque will be captured, the stator 86, or its part 181, is connected, torsion-proof, to the bearing assembly or the side frame 11; 12. This is accomplished, for example, via one or more anti-rotation elements 187, such as, for example coupling 187 that are positive, in terms of a direction of rotation, between the stator 86 or its part 181 and a part that is fixed to the frame or the bearing, such as is represented, for example, by the housing 182. In FIG. 15, the torsion-proof connection is formed by one or more stops 188, such as pins, which are arranged on the stator 86, and which is or are guided in a guide 189, such as, for example, a bore hole, in the housing. This can also be configured in the reverse manner. In this embodiment, the anti-rotation elements 187 that form a positive connection in the direction of rotation do not have a positive connection in an axial direction within their axial freedom of movement, and instead have, for example, only an end stop.

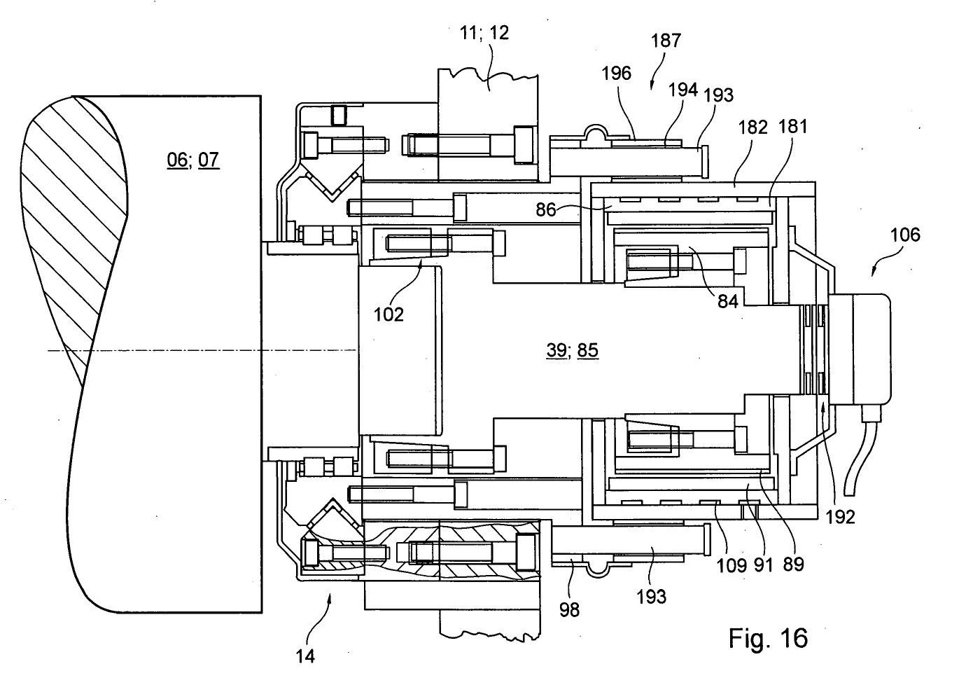

The sensor 106 can be connected to the housing 182, either as represented in FIG. 12, or, as represented in FIG. 15, via a clamping element 191, such as, for example, a clamp or a so-called socket. In FIG. 16, the sensor 106 is essentially rigidly connected to the housing 181 via the clamping element 191, and axial relative movement between the shaft 39; 85 and the rotor of the sensor occurs via a torsion-proof, or a torsion-rigid coupling 192 that nevertheless supports relative axial movement, such as a square-tooth coupling, but preferably occurs via a so-called multi-disk or all-metal coupling.

In the variation showing the configuration of the axially movable stator according to FIG. 16, which is not part of the invention, the housing 182 is connected to the bearing assembly 14, or the side frame, in a manner that is not rigid to compression/tension, but which is itself axially movable, but is torsion-proof. The part 181 of the stator that supports the windings 91 is, for example, rigidly connected to the housing 182, so that housing 182 and stator 86, or the part 181, move together axially. The housing 182 is arranged to be torsion-proof in relation to the bearing assembly 14 or to the side frame 11; 12, but to be axially movable, at least within certain limits. This is again accomplished, for example, via a positive anti-rotation element 187.

In FIG. 16, which is not part of the invention, the torsion-proof connection including the anti-rotation elements or coupling 187, is formed by one or more stops 193, such as pins 193, which are arranged on the clamping element 98 and acting in the direction of rotation, which stop or stops is, or are guided in a guide 194, such as a bore hole 194, that is stationarily fixed to the housing. The guide or bore hole 194 can be configured as a bore hole in a link plate 196 that is stationarily fixed to the housing 182. Guide 194 can also be configured in the reverse manner. The link plate can be configured as a collar-like circular ring, in which a plurality of these guides 194, or in the reverse manner, a plurality of pins are arranged. Between the parts that are capable of moving axially in relation to one another, in this case the housing 182 or the link plate 196, and the clamping element 98, a seal 197, or some other type of cover, can advantageously be arranged. In this case again, the anti-rotation elements 187, that form a positive connection in the direction of rotation, have no form closure in an axial direction within their axial freedom of movement, and instead have, for example, only an end stop. In this context see a widening at the end of the pin 193, for example.

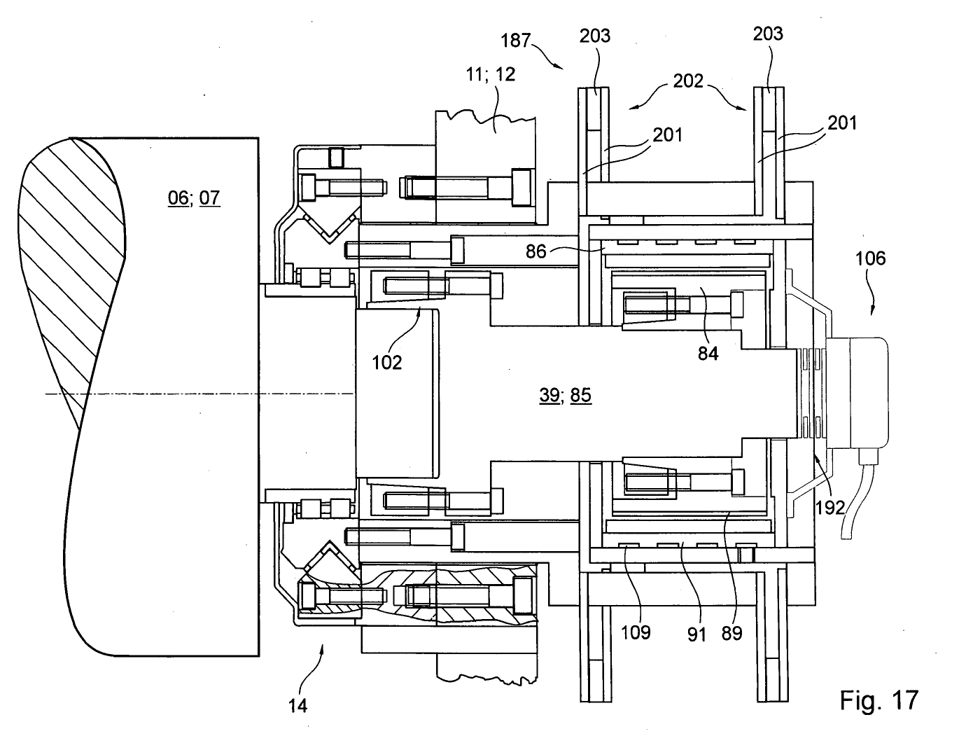

In FIG. 17, which is not a part of the invention, the anti-rotation element 187 is configured as a coupling 187 that is based upon the deformation of individual disks 201, or of disk packets, for example in the manner of a multi-disk or a full-metal coupling. The part 181 of the stator that supports the windings 91, or the housing 182, is connected to the clamping element 98 or to the bearing block 34 via a group of at least two spring elements 202 that are spaced from one another in the circumferential direction. The spring elements 202 each have at least two disks 201 or disk packets that are connected to one another at one end, for example via a spacer 203, with their other ends being connected to the part 181 of the stator that supports the windings 91, or to the housing 182, on one side and to the clamping element 98 or to the bearing block 34 on the other side. The housing 182 or the stator 112 can now be moved axially in relation to the clamping element 98 or in relation to the bearing block. The relative movement is supported by a deformation of the spring elements 202. The group of spring elements has at least two of these individual spring elements 202, which are preferably offset from one another by 150 degrees to 210 degrees in a circumferential direction. In this manner, a radial offset caused by axial movement is prevented. In one advantageous embodiment—as represented in FIG. 17—a second group of spring elements 202, that is spaced in an axial direction from the first, is included. Again, one end of the spring element 202 is arranged “fixed to the stator” and the other is arranged “fixed to the bearing block”. In this manner, a tilting of the stator 112 or the housing 182 that comprises the stator 112 is prevented.

In the embodiments shown in FIGS. 14 through 17, therefore, although the windings 91 are connected to the bearing block 34 in a torsion-proof manner, when viewed in an axial direction of the allocated cylinder 06; 07, they are connected so as to be movable relative to the bearing block 34 within certain limits, such as, for example, of at least 1 mm, especially of at least 2 mm. The anti-rotation element 187, which enables axial relative movement, between the part 181 of the stator that supports the windings 91 and the bearing block 34, forms a torsion-proof coupling 187 that nevertheless supports an axial relative movement, which can be configured with corresponding stops, such as, for example, with guided stops from FIGS. 15 and 16 or, as represented in FIG. 17, with a torsion-proof or torsionally stiff so-called multi-disk or a full-metal coupling 187 with corresponding spring packets, which nevertheless accommodates axial relative movement.

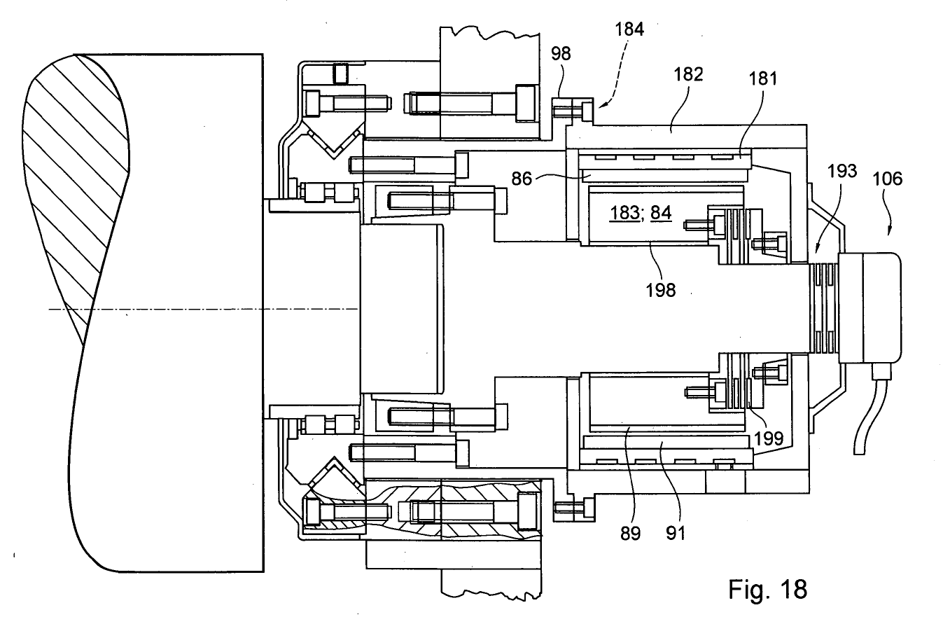

Conversely, in another advantageous embodiment of the drive motor 81, which is not part of the invention, the stator 86 is arranged fixed to the frame or to the bearing in the axial direction. The part 183 of the rotor 84, such as the rotor body, that supports the magnets is capable of moving axially, at least to a certain degree, in relation to a shaft that is fixed to the cylinder, and thus consequently also in relation to the cylinder 06; 07, as seen in FIG. 18. The part 183 of the rotor 84 that supports the magnets, however, is configured to be torsion-proof in relation to the cylinder 06; 07 or to the shaft 39; 85 with respect to transmitted torque such as, for example, via an anti-rotation element 199. The part 183 of the rotor 84 that supports the magnets, and the shaft 39; 85, can be moved in relation to one another in an axial direction via sliding surfaces or by similarly acting elements. The anti-rotation element 199, situated between the shaft 39; 85 and the rotor body 183, and which enables axial movement, can be configured either as corresponding stops, for example, in the groove and spring principle or with stops that are comparable to those of FIGS. 15 and 16 or, as represented in FIG. 18, as a torsion-proof or a torsionally stiff coupling 199 that nevertheless supports relative axial movement, for example as a square-tooth coupling, but preferably is configured as a so-called multi-disk or full-metal coupling. If, for example, the cylinder 06; 07 is moved axially, the rotor 84 or the rotor body 183 is not necessarily moved along with it axially. Rather, it can remain in place axially, stationary in the extreme case, as a result of magnetic interaction with the stator 86, such that the magnets of the stator 86 and rotor 84 can remain in the optimal operating position in relation to one another.

To this extent, the variations which are represented in FIG. 15 through 18, or their principle of operation can be applied to subsequent preferred embodiments of the drive motor 81, or to other drive motors, as will be discussed below and as depicted at 139; 140; 141; 142; 143; 162; 163. Although the drive motor 81, or others, in this case is preferably configured as a permanent magnet synchronous motor, it can also have corresponding windings in place of the permanent magnets 91 for use in the electrical generation of the magnetic fields.

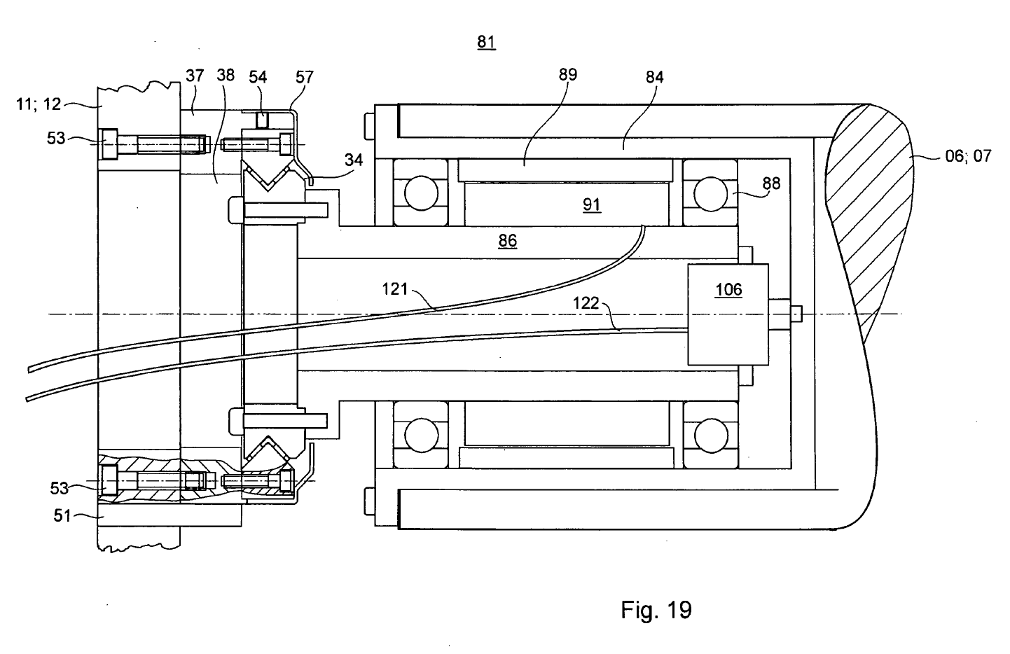

In a third embodiment of the drive unit for the rotating component, which is not part of the invention, such as, for example, a cylinder 06; 07 or a roller, the drive motor 81 is configured as an external-rotor motor for its rotational drive, especially also with permanent magnets 89 on the external rotor 84, as seen in FIG. 19. In this case, the rotor 84 is connected, for example, to the circumferential surface of the cylinder 06; 07, or is formed by it. The windings 91 of the stator 86 are supplied with power, for example, via electrical lines 121. In principle, the sensor 106 can be connected, torsion-proof, to the cylinder 06; 07 and/or to the rotor 84, at the most opposite point, such as, for example, at the other end surface of the cylinder 06; 07. Sensor 106 has, for example, a signal line 121 for the purpose of drive control. In this example, it is connected to the rotor 84. Stator 86 and rotor 84 are supported against one another via bearings 88, which in this case, are radial bearings 88. For this purpose, the radial bearings 31 in the bearing block 34 of FIG. 6 or 7 are omitted. The stator 86 is connected, in a torsion-proof manner, to the bearing block 34, and can be moved together with it, especially in a linear fashion. In the case of non-movable rotating components, such as cylinders of a folding unit or drawing rollers, for example, the principle can be transferred, without the use of the bearing unit 14.

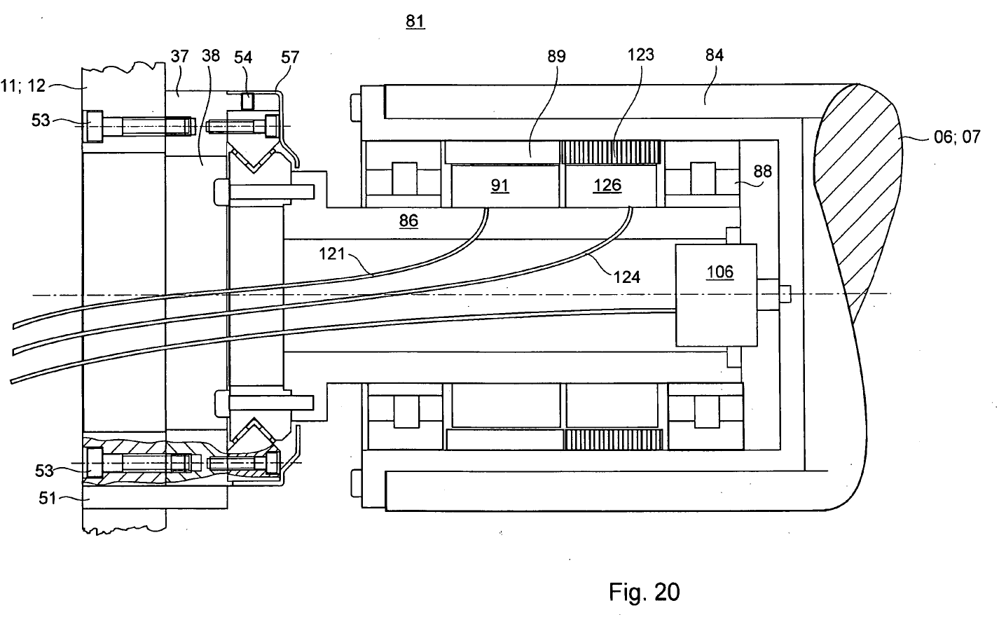

FIG. 20 shows an advantageous variant, also not a part of the invention, in which, especially in the case of a cylinder 07, which is configured as a forme cylinder, axial movement is also to be caused by the drive motor 81. To this end, the rotor 84 has a section that is fitted in a different manner with permanent magnets 123. The poles of the permanent magnets 123 alternate, for example, in an axial direction. Conversely, for example, the poles alternate in the section of permanent magnets 89 that is provided for rotational actuation, for example in the circumferential direction, as is also seen in FIGS. 10, 12 and 15. Windings 126, that are different from the windings 91, are arranged opposite the section of permanent magnets 123 which have been provided for axial movement, these windings being controlled, via designated signal lines 124, by a machine control system for the purpose of lateral register adjustment. In this case, the bearings 88 are configured, for example, as roller bearings 88 that enable relative axial movement.

If, as is the case with the printing group cylinders 06; 07, a plurality of rotating components, which are arranged side by side, are each to be actuated by drive motors 81, the physical size of the drive motors 81 is limited by the spacing between the rotational axes of adjacent rotational components, when these overlap in relation to the distance to the allocated component. However, the size of the motor, especially in the configuration of the drive motors 81 as direct drives, without the interposed connection of transmissions, can, under certain circumstances, be greater than the component diameter, such as, for example, can be greater than the cylinder diameter.

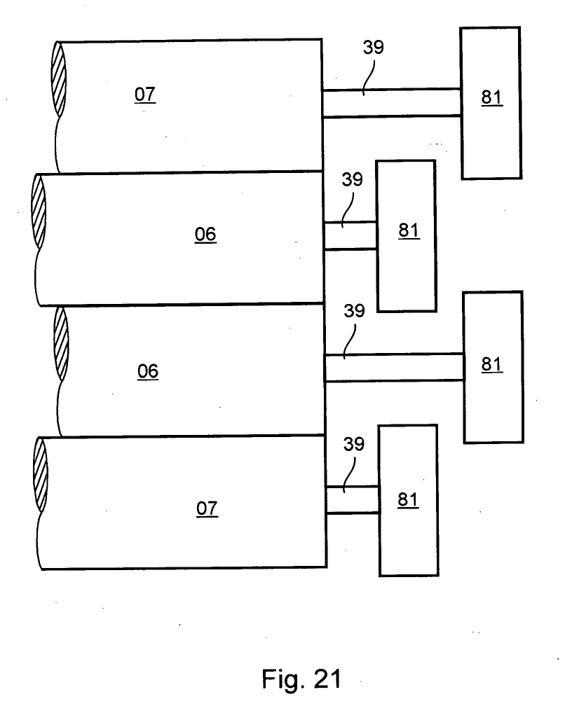

A first possible solution, as shown schematically in FIG. 21, is to offset adjacent drive motors 81 axially in relation to one another, for example in the embodiment of FIG. 10 or 12, such that they do not intersect one another in any plane that lies perpendicular to the direction of rotation. To this end, the shafts 39 of alternating ones of the motors 81 can be longer in configuration, as seen in FIG. 6, or intermediate shafts can be provided.

In one advantageous embodiment, especially if structural space is limited, for example in the case of a drive unit for printing group cylinders 06; 07, the stator 86 can be segmented, or can be formed from one or more segments, wherein each such segment does not encompass the entire circumference, or, in the case of a plurality of segments, this plurality of segments together do not encompass the entire circumference. One or more stator segments 86′ thus encompass only one circumferential angle that is smaller than 360 degrees, for example is smaller than 300 degrees, and especially is smaller than 240 degrees. If two segments are provided, these can be arranged in any pattern around the circumference of the circle depending upon structural space, each encompassing a circumferential angle that is smaller than 150 degrees, and especially is smaller than 120 degrees. The stator 86, which is formed by the at least one stator segment 86′ or the stator segments 86′, or the fitting with windings 91, does not reach entirely around the circumference of a circle, but only partially, around the circumference of the circle. In one advantageous embodiment, when two stator segments 86′ are used, these two stator segments are arranged opposite one another, and are thus distributed evenly in a circumferential direction.

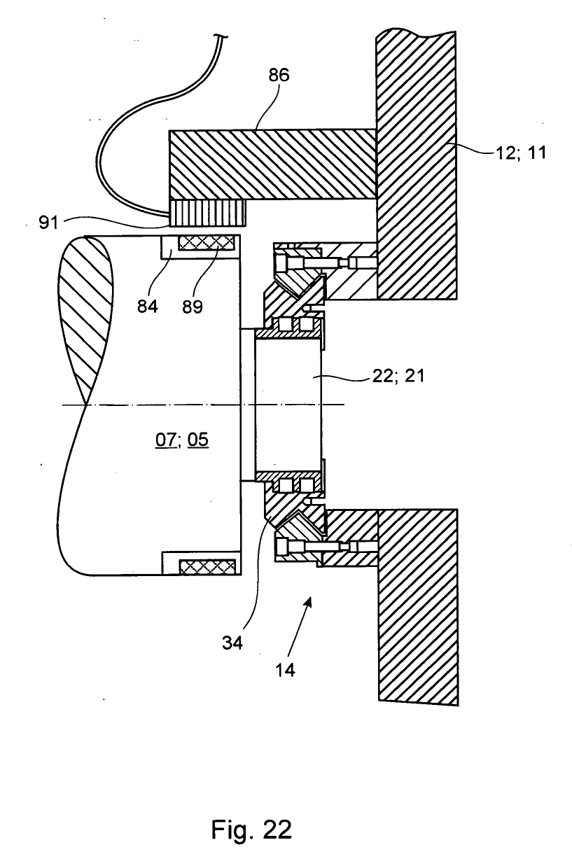

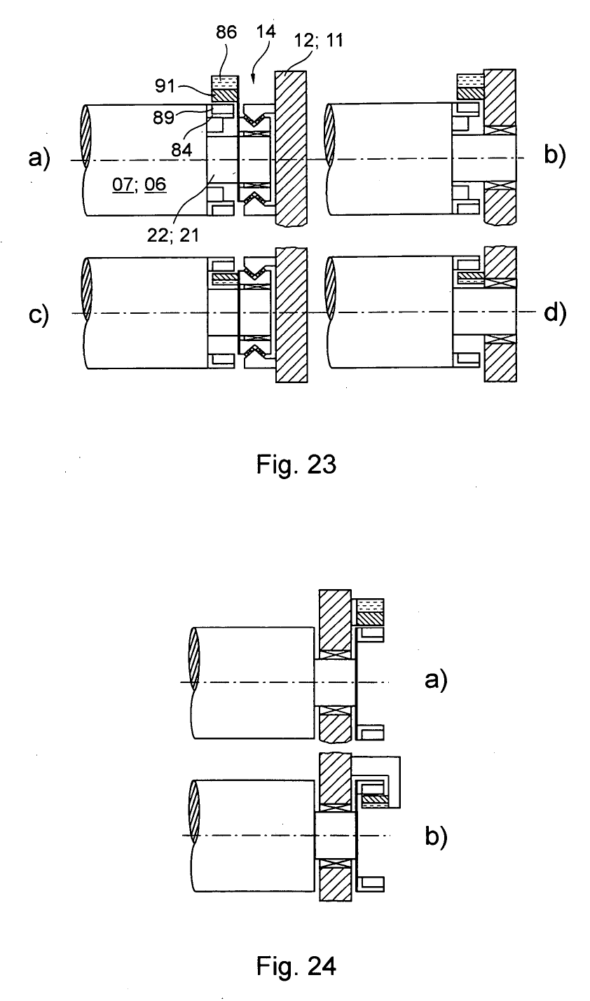

FIG. 22 details one of many variations of this embodiment for the configuration of the drive unit, which are not part of the invention. In this case, an effective area between stator 86 and rotor 84, or an effective surface between the permanent magnets 89 of the rotor 84 and the windings 91 of the stator 86, extends parallel to and, for example, coaxially with the axis of rotation of the cylinder 06; 07 or the rotating component. The cylinder 06; 07 is equipped with the permanent magnets 89, for example, in the area of its circumferential surface or in an end surface extension, in a circumferential direction. The stator 86 that is equipped with the windings 91 is arranged, stationary, outside of the cylinder 06; 07, or of a roller, but between the two side frames 11; 12. The stator 86 that supports the windings 91 extends only over an angular segment. In this regard, see FIG. 23 through 26. However, the permanent magnets 89 can also be arranged on a journal 21; 22 or at an end-surface or narrowed area of the cylinder 06; 07 or of the rotating component. Because, in this case, the stator 86 is arranged on the side frame 12 or 11, in the case of an optionally movable cylinder 06; 07 the shape of the stator 86 and/or its distance from the rotor 84 must be accounted for accordingly. See, for example, FIG. 28.

The principle of the segmented stators 86, which is shown in detail in FIG. 22, is represented schematically for various variations in FIG. 23 through 26. Reference symbols for the essential components have been provided only in FIG. 23a. These reference symbols can be easily transferred to the remaining variations.

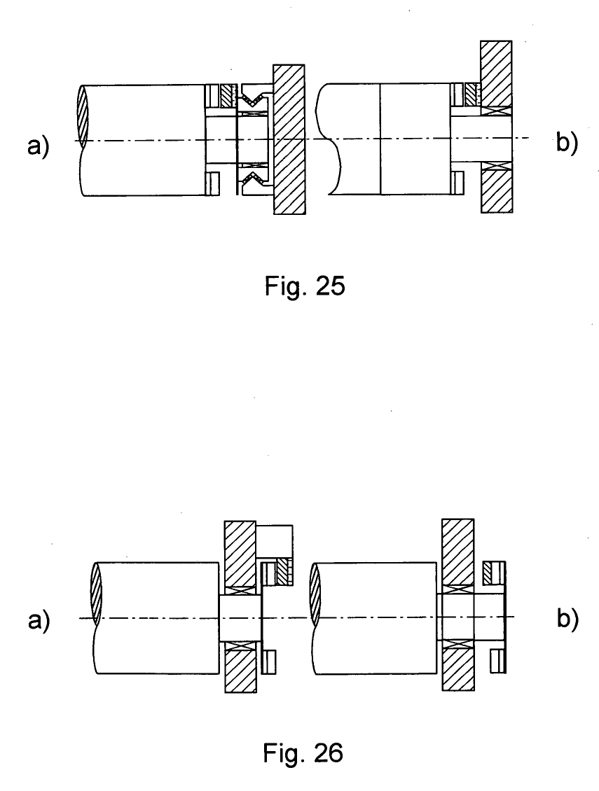

A first series of variations, which are represented in FIGS. 23 and 24, involves arrangements of stator 86 and rotor 84, wherein an effective surface between stator 86 and rotor 84, or an effective surface between the permanent magnets 89 of the rotor 84 and the windings 91 of the stator 86, lies parallel to and, for example, coaxially with the axis of rotation of the cylinder 06; 07 or of the rotating component, in short, an axially parallel arrangement. FIGS. 25 and 26 involve arrangements of stator 86 and rotor 84, wherein an effective surface between stator 86 and rotor 84, or an effective surface between the permanent magnets 89 of the rotor 84 and the windings 91 of the stator 86, lies perpendicular to the axis of rotation of the cylinder 06; 07 or to the rotating component, in short, an axially vertical arrangement.

FIGS. 23 and 25 also involve variations, wherein rotor 84 and stator 86 lie on the side of the side frame 12; 11 that faces the cylinder 06; 07 or that faces the rotating component, and FIGS. 24 and 26 involve variations in which rotor 84 and stator 86 lie on the external side of the side frame 12; 11 that faces away from the cylinder 06; 07 or from the rotating component. FIGS. 23a, 23c and 25a show variations that account for a bearing assembly 14 for moving the cylinder 06; 07 or a movable component, whereas FIGS. 23b, 23d, 24a, 24b, 25b, 26a and 26b show the variations for a customary side panel mounting of the rotating components. The diagrammatic representation of FIGS. 24a and 24b that takes bearing assemblies 14 into account has been omitted.

FIGS. 23a, 23b and 24a show drive motors 81 in the configuration of an internal-rotor motor, whereas FIGS. 23c, 23d and 24b show external-rotor motors.

In each of the variations, according to FIGS. 23a, 23c and 25a, the stator 86 is arranged on the movable part of the bearing assembly 14, and especially is arranged on the bearing block 34.

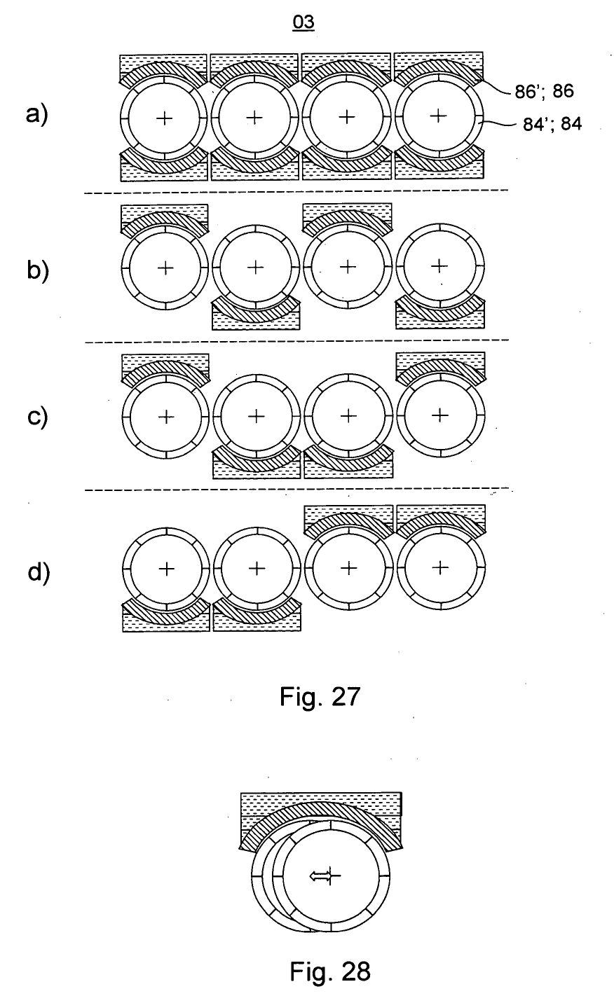

The segmented configuration of the stators 86 offers a wide range of possibilities for space-saving arrangement, four variations of which are represented in FIG. 27, using the example of the axially parallel arrangement in the context of a blanket-to-blanket printing group 03. The teaching can be applied accordingly to differently configured, aforementioned variations. In FIG. 27a, the drive units for the cylinders 06; 07 each have two segmented stators 86, such as, for example, stator segments 86′. In FIG. 27b through 27d, only one stator segment 86′ is allocated to each drive unit.

For the case, which is not a part of the invention, in which the stators 86 or stator segments 86′ are configured to be stationary and the rotating component, and especially the cylinder 06; 07, is configured to be movable in a direction that is perpendicular to its axis of rotation, the stator segment 86′ is configured such that movement of the cylinder 06; 07 is ensured within certain limits, as depicted in FIG. 28. To this end, the radius of the effective stator surface is selected such that an air gap is not closed, even in the end position of the cylinder 06; 07. This is especially advantageous, in arrangements according to FIGS. 23b, 23d, 24a and 24b, when the bearing is configured as an eccentric bearing which is situated between side frame 12; 11 and journal 22; 21.

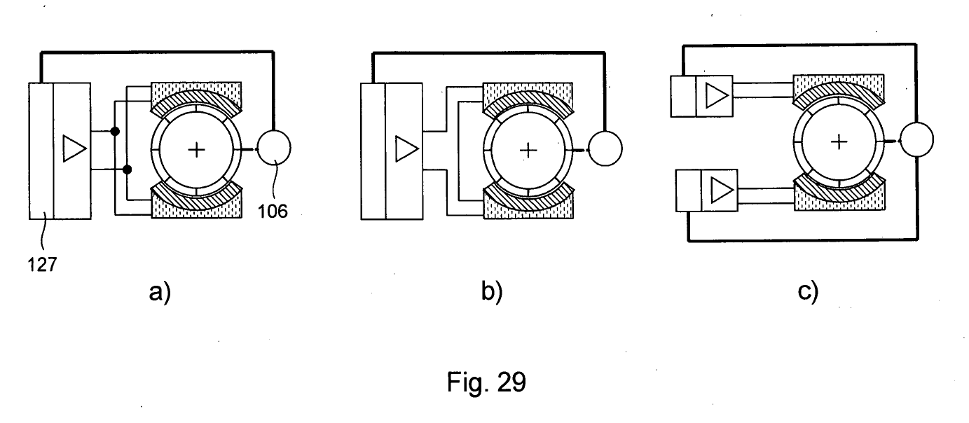

When a plurality of stator segments 86′ are used for each drive unit, the windings 91 can be connected either parallel or serially, and can be operated via a control device 127, as seen in FIG. 29a). A separate control of the windings 91 via different control devices 127 is also conceivable. Only one sensor 106, such as, for example, configured as an angular position sensor 106, is necessary, which sensor 106 supplies all of the control devices 127 with the position signals for the actual position. The position offset of the stator segments 86′, in relation to one another, can be parameterized accordingly in the control device 127 or the control devices 127. A sufficiently precise arrangement of the stator segments 86′, in relation to one another, in the circumferential direction is necessary to keep the stator segments 86′ from working against one another during operation. To accomplish this result, it is advantageous to maintain a level of precision of less than one-tenth of an angle distance for the same side of two like, sequential poles. For example, with 12 pole pairs in the segment, and extending over an angle of, for example, 120 degrees, 24 poles, having a respective distance of the same side of 5 degrees are present. The distance of like poles then extends to 10 degrees and the maximally permissible angle error to 0.1 degree.

In this embodiment, it is also advantageous to configure the stator segments 86′ to be liquid cooled. The sensor 106 can be arranged on the rotor 84 itself, on the journal 21; 22 on the same side of the cylinder as the rotor 84, or on the opposite journal 22; 21. Of particular benefit is a configuration having a large number of pairs of poles per drive unit, for example 12 pairs of poles.

As indicated in FIGS. 27, 28 and 29, in one advantageous embodiment, the rotor 84 can be configured to be separable into a plurality of segments. The rotor 84 is then comprised of a plurality of rotor segments 84′, such as, for example, three, four, six or eight such segments, in a circumferential direction, which together cover the entire circumference of 360 degrees, but which can be installed or uninstalled individually. The cover is without holes. For example, between the rotor segments 84′ there is no significant deviation from the spacing pattern of the alternating poles, either permanent magnets or windings, or a distance of two rotor segments 84′ in the circumferential direction amounts, at most, to 5 degrees. In this manner, it is especially possible to install or to uninstall the rotor 84, without also removing the cylinder 06; 07 or the allocated rotating component.

If the rotating component is configured as a roller, or if there is ample space between adjacent cylinders 06; 07, in a fourth embodiment, which is not specifically shown here, the stator 86 that supports the windings 91, as represented in FIG. 22 through 26, can be configured not as a segmented stator 86, but to extend around the entire circumference of the roller or of the cylinder 06; 07.

In the embodiment of the drive unit for a cylinder 06; 07, specified with reference to FIGS. 6 and 10, the drive motor 81 is configured especially as a permanent magnet synchronous motor 81.

The coupling which is described in connection with FIG. 12 is advantageous for a drive motor 81 which is configured as a permanent magnet synchronous motor 81. However it can also be advantageously used for differently configured drive motors 81, such as, for example, asynchronous motors, especially those having a speed-reducing adapter transmission.

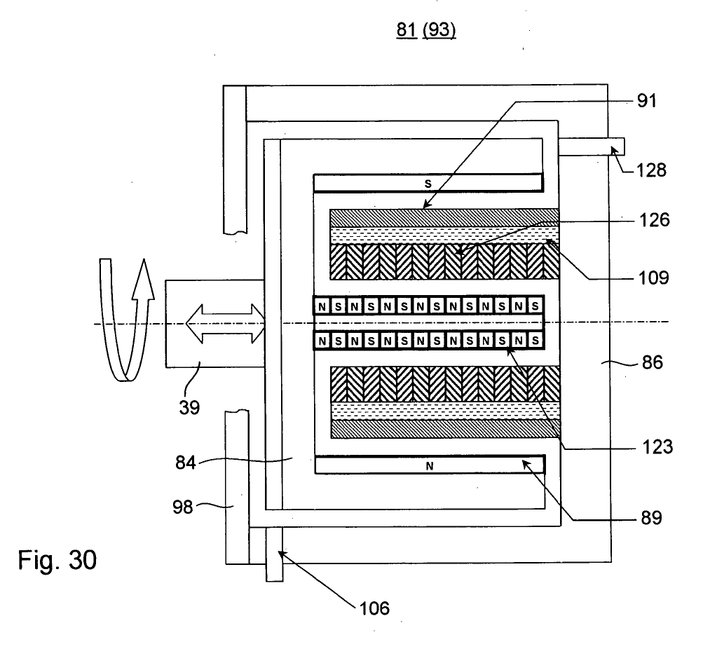

In a further preferred embodiment of the coupling of the rotating component, and especially of the component which is configured as a forme cylinder 07, as is schematically represented in FIG. 30, in contrast to the embodiment that is shown in FIG. 20, a linear drive unit for axial offset, or lateral register, is integrated into the drive motor 81. The components of the axial and the rotary drive unit can, in principle, be arranged in series in an axial direction, as shown in FIG. 20. In one advantageous variation, however, these are arranged coaxially in relation to one another and to the motor shaft or to the shaft 39. In FIG. 30, the windings 91; 126 for the radial and for the axial drive units, the permanent magnets 89; 123 for the radial and for the axial drive units, the rotor 84 that supports the permanent magnets 89; 123 and the stator 86 that supports the windings 91; 126 are represented. A sensor 106 that detects the torque angle, a sensor 128 that detects the axial position, and a coolant channel 109 are also provided. The connection can either be made, as represented in FIGS. 6 and 10, stationarily via couplings 82, or, as indicated in an advantageous embodiment, can be via a bushing 98, as shown in FIG. 12. In principle, variations which are not specifically shown here, are possible, wherein the rotary drive unit, which is arranged on the exterior in FIG. 30, is arranged on the interior, and the axial drive unit is arranged on the exterior. In this case, the permanent magnets 89; 123 and the windings 91; 126 are reversed.

The coupling of the drive motor 81 to the cylinder 06; 07, as described in reference to the example of the printing group cylinder 06; 07, preferably has a detachable connection between journal 21; 22 and shaft 39 or motor shaft 85, such that when the cylinder 06; 07 is in its mounted state the journal 21; 22 does not penetrate through the side frame 11; 12. In this case, the drive connection between the cylinder 06; 07 and the drive motor 81, which is especially arranged essentially coaxially to the axis of rotation of the cylinder 06; 07, has multiple parts, with at least one journal 21; 22 and a shaft 39 that is connected to the former in a torsion-proof but detachable manner, which shaft 39 can also simultaneously comprise the motor shaft 85.

In addition to the drive units for the printing group cylinders 06; 07, the printing group 04 or the blanket-to-blanket printing group 03, as shown in FIG. 11, has at least one drive unit for a roller 92, and especially for an oscillating roller 92, such as the distribution cylinder 92 of the inking unit 08 and/or the dampening unit 09.

The actuation of the at least one roller 92 can be accomplished, as shown in FIG. 11, by an end-surface drive motor 93 via a transmission 94. In this case, the drive motor 93 can be configured, in principle, as an asynchronous motor or as a synchronous motor.

In an embodiment of the inking unit drive, that is advantageous in terms of a direct coupling without a reduction gear, the drive motor 93 of FIG. 11 is configured as a synchronous motor 93, and especially as a permanent magnet synchronous motor 93. In this case, the transmission 94 has, for example, no rotary reduction gear, but is only a transmission that converts rotational motion into oscillating motion, such as, for example, an oscillating gearing. In this first embodiment for the inking unit drive, then, no specifically designated drive motors are provided for generating the oscillating motion. In FIG. 11, two distribution cylinders 92 are provided in the inking unit 08, both of which can be actuated into rotation and oscillation, for example, via a mechanical drive connection, by the drive motor 93. In one variation, only the distribution cylinder 92 that is positioned most remotely from the forme cylinder 07 is rotationally actuated.

In one particularly advantageous embodiment, the drive motor 93 of the inking unit drive, which drive motor 93 is here configured as a permanent magnet synchronous motor 93, and which is comparable to the drive motor 81 of FIG. 30, has a drive motor 93 in which both rotary actuation and axial actuation are integrated. With respect to one embodiment, reference is made to the schematic representation and to the associated description directed to the configuration which is depicted in of FIG. 30.

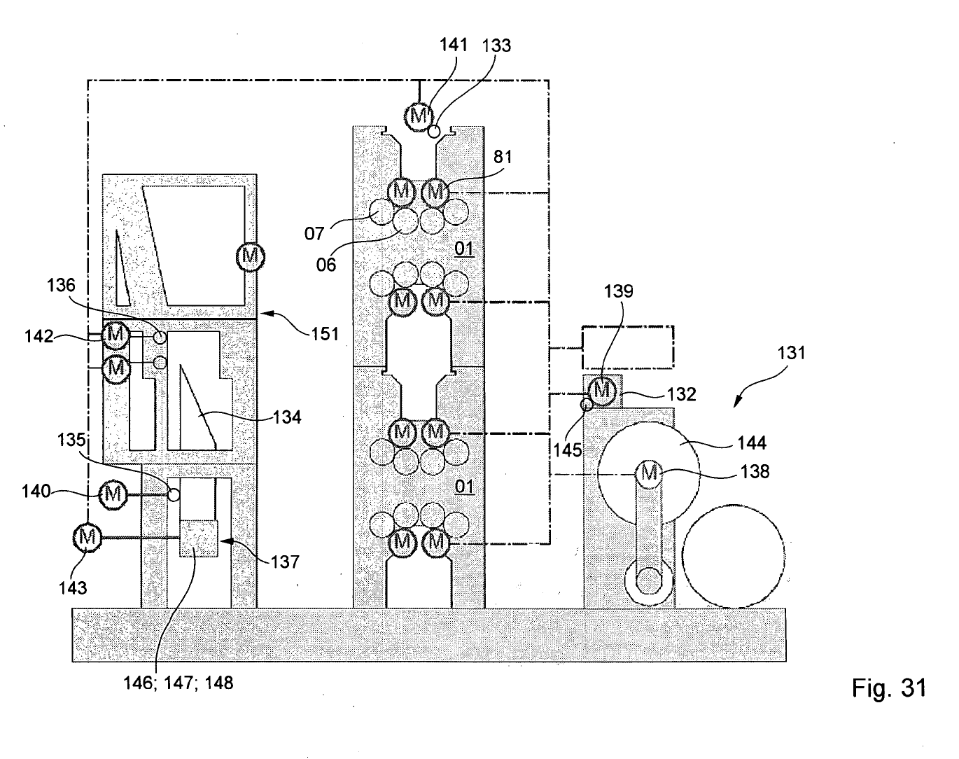

In FIG. 31, basic elements of the printing press are combined. In the printing units 01, the above-described drive motors 81 are provided for the rotating components 06; 07, which are configured as printing group cylinders 06; 07. Further, for example, a reel changer 131 has a drive motor 138 that actuates a material roll 144, and/or a drawing roller 145 of an infeed unit 132 has a drive motor 139, and/or a drawing roller 133, which is arranged downstream from the printing units 01, has a drive motor 141, and/or a drawing roller 136, which is arranged upstream from a folding former 134, has a drive motor 142, and/or a drawing roller 135, that is arranged downstream from a folding former 134, has a drive motor 140, and/or at least one cylinder 146; 147; 148 of a folding unit 137 also has a drive motor 143.

The material roll 144, the drawing roller 145, the drawing roller 133, the drawing roller 135, the drawing roller 136, and the cylinders 146; 147; 148 all represent independently actuated rotating components 144; 145; 133; 135; 136; 146; 147; 148 and can also be those “rotating components” which were described above in connection with the printing group cylinders 06; 07, and which are actuated by the drive motors 138; 139; 141; 140; 142; 143. In this context, the drive motors 138; 139; 140; 141; 142; 143 can be coupled to their associated allocated component 144; 145; 133; 135; 136; 146; 147; 148 in a manner which was previously described in connection with the printing group cylinder 06; 07. However, however, in each case, the bearing assembly 14 that enables on/off adjustment can be omitted. Under certain circumstances, the angle or the offset compensating coupling 82 can also be omitted.

In one advantageous embodiment, the drive motor 138; 139; 141; 140; 142; 143 that actuates the rotating component 144; 145; 133; 135; 136; 146; 147; 148 can be configured in the manner which has been described above as a drive motor 138; 139; 141; 140; 142; 143 that is configured as being energized by permanent magnet and/or as a synchronous motor 138; 139; 141; 140; 142; 143. In this case, however, the axial drive, which was provided in a number of embodiments, can be omitted. There can also be differences in the rated torque and the maximum torque. One, several, or all of these drive motors 138; 139; 140; 141; 142; 143 can be configured in the manner of the drive motor 81 which is configured as a permanent magnet synchronous motor 138; 139; 141; 140; 142; 143.

Separate drive motors 81; 138; 139; 141; 140; 142; 143, especially ones configured as drive motors 81; 138; 139; 141; 140; 142; 143 that are configured as being energized by permanent magnet and/or as synchronous motors 81; 138; 139; 141; 140; 142; 143 can be provided in the printing units 01 and/or on the folding unit 137 and/or on a drawing roller 145, such as, for example, in the folding unit 151 or in the infeed unit 132, and/or on the reel changer 138.

What has been described with respect to the coupling of the synchronous motor 81 in the context of FIG. 19 through 26, but without the bearing assembly 14, can also be applied to the rotating components 144; 145; 133; 135; 136; 146; 147; 148, which require no axial movement and/or similar adjusting movement perpendicular to the axis of rotation.

In FIG. 31, a drive control is indicated schematically by a dotted-dashed line connecting the drive motors 81; 138; 139; 140; 141; 142; 143, and is described below in greater detail in reference to FIG. 37.

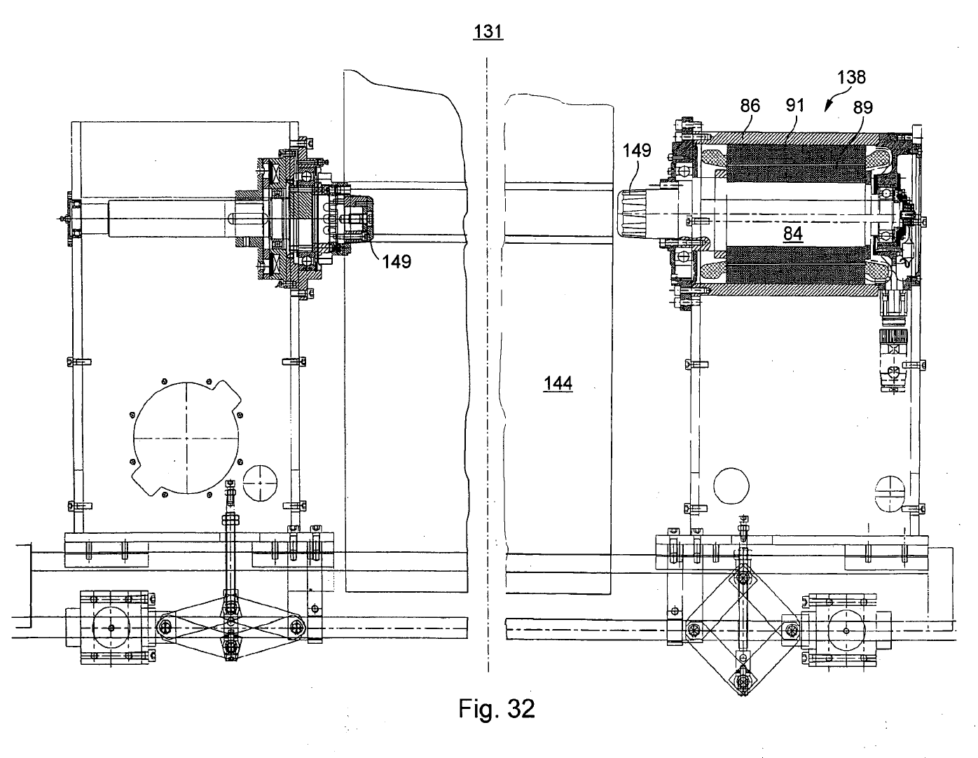

FIG. 32 shows a front elevation view of a preferred embodiment of a reel changer 131 with the drive motor 138 configured as a synchronous motor 138, and especially as a motor 138 which is energized by permanent magnet 89, as discussed above, by the use of which, the material roll 144, that is placed on the axle, is actuated and is unrolled. At least one of two chucks 149 is actuated, for example, by a synchronous motor 138 with permanent magnets 89, as described above, on the rotor 84, and with windings 91 on the stator 86. The other chuck 149 can be non-motor actuated, as represented, or may also have a drive motor 138 of this small type. In this case, the chuck 149 is configured as being non-expandable, but could also be configured to be expandable.

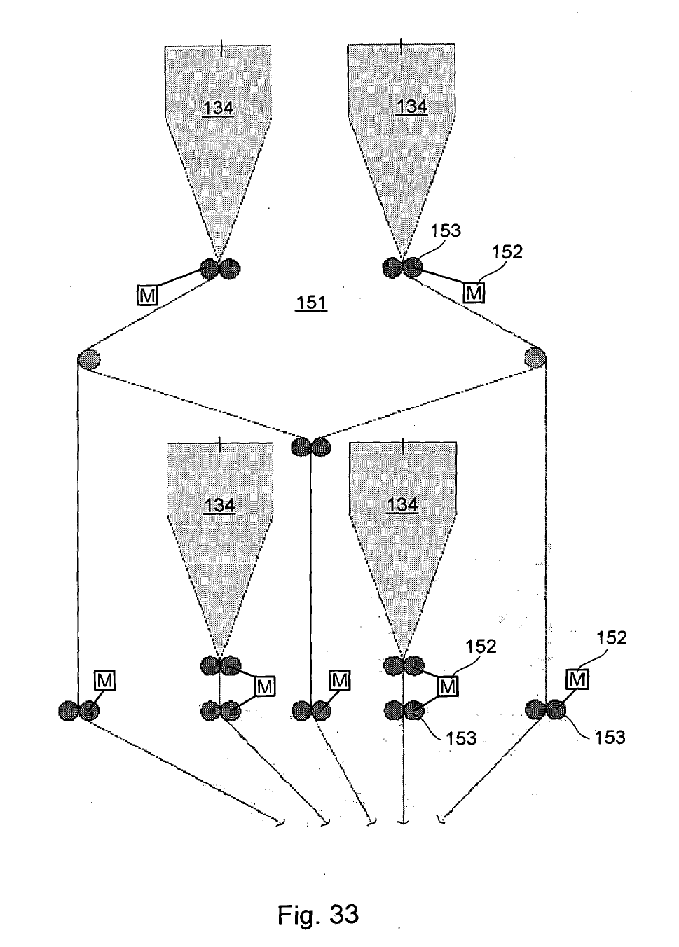

FIG. 33 shows a schematic view of a folding unit 151 having a plurality of folding formers 134, with drawing rollers 153 which are provided as rotating components 153 that are actuated by drive motors 152. These drive motors 152 can also be configured, as described above, as directly coupled synchronous motors, and especially as motors which are energized by permanent magnet. In addition to the drawing rollers 133; 153, which are represented in FIGS. 31 and 29, actuated guide elements of a superstructure can also have a drive motor in the manner of a synchronous motor, as described in one of the embodiments above.

The drive motor 81 of the cylinder 06; 07 and/or the drive motor 93 of the inking unit 08 and/or the drive motor of the dampening unit 09 and/or the drive motor 143; 162 in the folding unit 137 and/or the drive motor 139; 140; 141; 142; 152; 163 of a drawing roller 133; 135; 136; 145; 153; 164, located in the superstructure and/or in the folding unit 151 and/or at the intake of the folding unit 137, and/or the drive motor 138 of the reel changer 131 can preferably be configured in the aforementioned embodiment of the drive motor 81 as a synchronous motor 81 and/or as a drive motor 81 which is energized by permanent magnet. In this case, the drive unit for the cylinder 06; 07 can advantageously be supported by an angular position control, and the drive unit for the drawing rollers 133; 135; 136; 145; 153; 164 and the reel changer 131 can be supported by a speed control, if applicable, with a superimposed web tension control. Control of the drive motor 139; 140; 141; 142; 152; 163 is advantageously accomplished, for example, via an electronic guide axis, as is described in connection with FIG. 37.

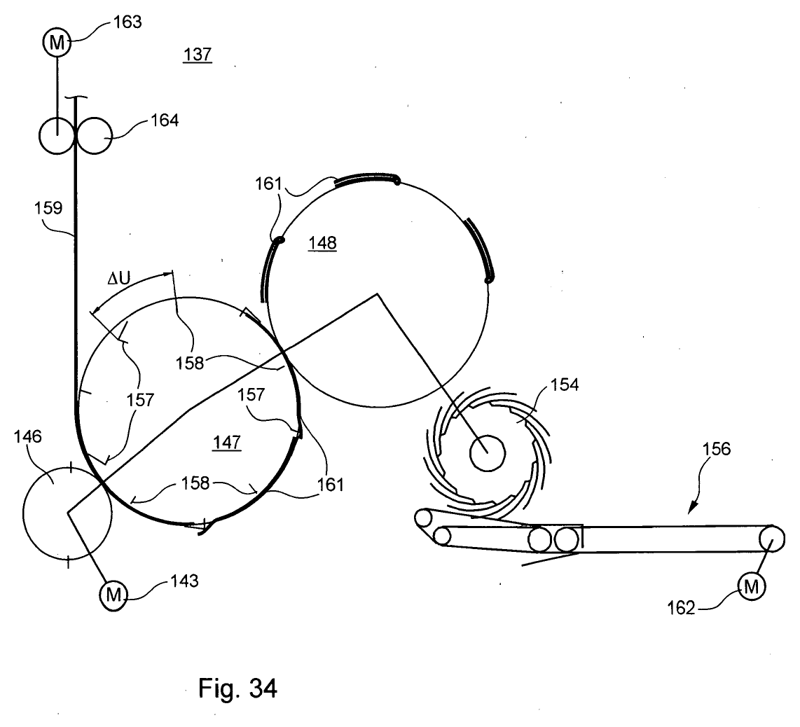

The folding unit 137, which is represented schematically in FIG. 34, has, for example, cylinders 146; 147; 148 which are configured as a cutting or blade cylinder 146, a transport cylinder 147, and a jaw cylinder 148, respectively. The folded product can then be delivered to a paddle wheel 154 and from there to a delivery point 156. At least the transport cylinder 147, which is configured as a folding blade cylinder 147, can be configured to have a variable format. A distance AU in the circumferential direction, between the clamping elements 157 and respective downstream folding blades 158 on the outer circumference of the transport cylinder 147, is configured to be adjustable. In this configuration, the clamping elements 157, which are configured, for example, as pin strips or grippers, on one side and the folding blade 158 on the other side, can be positioned on two different coaxially arranged drums, which two drums are capable of rotating with respect to one another in a circumferential direction. If the distance AU between clamping elements 157 and downstream folding blade 158 is decreased, then a section of product 161, that is cut crosswise off of a web strand 159 by the blade cylinder 146, is folded crosswise after a short section length when the folding blade 158 is extended, and vice versa. The strand 159 can consist of one or more longitudinally folded or unfolded webs 02 or partial webs.

Cutting cylinder 146, transporting cylinder 147, folding jaw cylinder 148; and, if applicable, paddle wheel 154 are preferably actuated by at least one drive motor 143, M, and especially at least one permanent magnet or synchronous motor 143, mechanically independently from printing units, superstructure and folding unit. Actuation of these several cylinders by the at least one motor 143 can be accomplished via a transmission, and especially via a reduction transmission, by use of the drive motor 143 positioned on one or more of the cylinders 146; 147; 148 of the folding unit 137.

In the embodiment which is represented in FIG. 34, actuation is accomplished by the drive motor 143 via a transmission that is not specifically shown, for example by the use of not identified sprocket or drive wheels on the cutting cylinder 146, or on one of a plurality of cutting cylinders. The cutting cylinder provides actuation for the transport cylinder 147, which, in turn, provides actuation of the folding jaw cylinder 148. If applicable, the folding jaw cylinder 148 can provide actuation of the paddle wheel 154 via a belt drive.

In a variation that is not specifically shown, the transport cylinder 147 is actuated by the drive motor 143 via a sprocket or a drive wheel. The transport cylinder provides actuation of the cutting cylinder or cylinders 146 and of the folding jaw cylinder 148. The folding jaw cylinder 148, for example, in turn provides actuation of the paddle wheel 154 via the belt drive. In both described cases, the delivery point 156 preferably has its own drive motor 162 (M), which is mechanically independent of the cylinders 146; 147; 148 and of the paddle wheel 154.

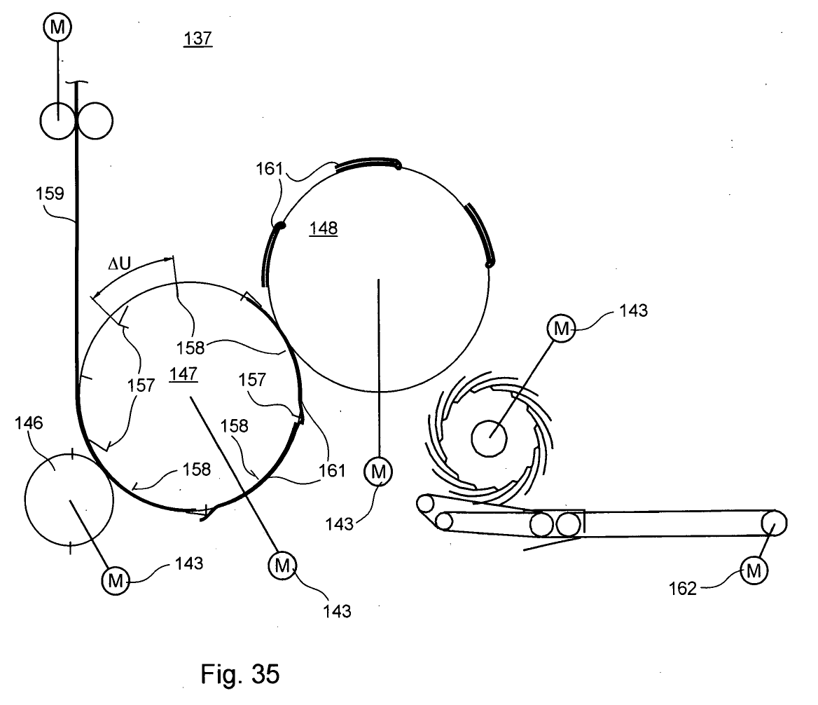

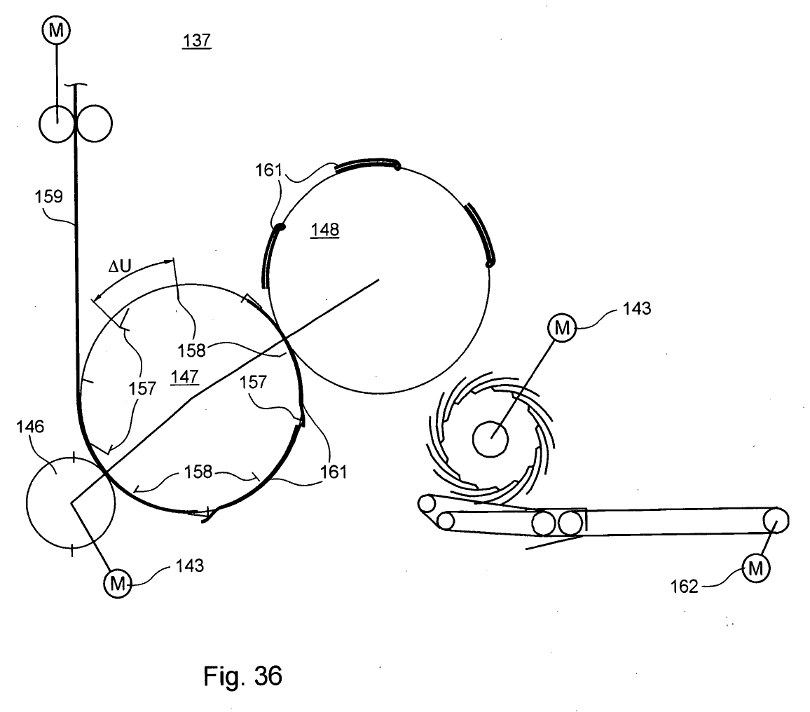

Cutting, transport and folding jaw cylinder 146; 147; 148, and, if applicable, paddle wheel 154 can also each be actuated mechanically independently from one another and from the printing groups 04 by their own drive motors 143; 162 (M), as is depicted in FIG. 35. In one variation, as shown in FIG. 36, the three cylinders 146, 147, 148 are actuated together, and the paddle wheel 154 and delivery unit 156 are each actuated separately.

In another drive embodiment, cutting, transport and folding jaw cylinders 146; 147; 148, respectively are each actuated by at least one shared drive motor 143, or alternatively are actuated each by its one drive motor that is mechanically independent of the printing groups. In a first variation the paddle wheel 154 and the delivery unit 156 are rotationally actuated by a shared drive motor, mechanically independently from the cylinders 146; 147; 148, and the printing groups 04, and in a second variation, each is activated by its own drive motor 143; 162 (M).

An optionally provided belt system, for use in conveying the product sections 161 in and through the folding unit 137, can be actuated by its own drive motor 162 (M), which is provided being mechanically independent from the cylinders 146; 147; 148.

The specified drive motors 143; 162 (M) can advantageously be configured, as described above, as permanent magnet synchronous motors 143; 162 (M).

In an intake area of the folding unit 137, a drawing roller 164, as seen in FIG. 34, and which is also actuated by a specifically designated drive motor 163, such as, for example, as a motor 163 which is energized by permanent magnet, can be provided as the rotating component 164.

In principle, the drive control, which will be described in what follow, is also advantageous independent of the special configuration of the drive motors 81; 138; 139; 140; 141; 142; 143; 162; 163 and of the special linear mounting of the cylinders 06; 07, as was described above. However, the drive control is especially advantageous for the directly actuated components in the aforementioned embodiments.

FIG. 37 shows an example of the drive unit of a printing press with a plurality of printing units 01, and in this case with two such printing units 01, configured as printing towers 01, each of which printing towers 1 comprises a plurality of printing groups 04, which in this case, are blanket-to-blanket printing units 03. The printing groups 04 of a printing tower 01, together with their drive controllers 166, shortened to drive units 166, and the drive motors 81; 93, form a group 167, for example drive motor group 167, and especially form a printing point group 167, which is connected, via a subordinate drive control 168 for this group 167, to a first signal line 171 that carries signals for a respective guide axis position φ of a virtual guide axis. However, the subordinate drive control 168 can also control sub-groups of printing units 01 or of other sections. Other units having their own subordinate drive controls 168, such as, for example, one or more guide elements, such as drawing rollers 133, 153, FIGS. 31, 33, of a superstructure and/or of a folding unit 151 and/or of one or more folding units 137 are also connected to this signal line 171. Not shown here is the connection to the reel changer 131 and to the infeed unit 132, which connections can be implemented in the same manner. In this case, the signal line 171 is advantageously configured as a first network 171 in ring topology, and is configured especially as a sercos ring, which obtains the guide axis position φ through a drive control 172 that is superordinate and is connected to the network 171. The drive control generates the continuous guide axis position φ on the basis of preestablished values for a predetermined production speed, which it receives from a computer and/or from a data processing unit 173, such as, for example, a section computer. The computer and/or data processing unit 173, in turn, receives the preestablished values for the production speed from a control center 174 or from a control center computer 174 which is connected to it.

In order to ensure printing and/or longitudinal cutting of the web that are true to register, the units that are actuated mechanically independently of one another, specifically, the printing groups 04 and the folding unit 137, for example, based upon a web lead, must be in the correct angular position in relation to one another. To accomplish this, offset values ΔΦ_{I} for the individual drive units 166 that require adherence to register are maintained, which offset values define the angular position relative to the shared guide axis and/or relative to one of the units that is correct for production. At least these units, printing groups 04 and folding unit 137, or their drive units 166 are subject to angular position control. Other units that guide the web 02, such as drawing rollers 133; 135; 136 and/or reel changer 131, need not necessarily be operated under angular position control, but may be subject to speed control.

The offset values ΔΦ_{I} that are relevant for the individual drive units 166, at least for the drive units 166 with register requirement, are supplied for the relevant production process by the computing and data processing unit 173 via a second signal line 176 that is different from the first signal line 171, and especially by a second network 176. These offset values ΔΦ_{I} are supplied, to the subordinate drive controls 168 that are assigned to the respective drive unit 166, and are stored there in an advantageous embodiment, and are processed using the guide axis position Φ to determine the corrected guide axis positions Φ_{I}′.

The offset values Δφᵢ are transmitted to the subordinate drive controls 168, for example either via corresponding signal lines from the second network 176 directly to the drive control 168, which arrangement is not specifically shown, or advantageously are transmitted via a control system 177, which control system 177 is allocated to the respective group 167 or to the unit that has its own subordinate drive control 168. In this case, the control system 177 is connected to the second network 176, or to the computer and data processing unit 173. The control system 177 controls and/or regulates, for example, the servo mechanisms that are different from the drive motors 81; 93 and drive units of the printing groups 04 or folding units 137, such as, for example, the ink delivery, adjustment movements of rollers and/or cylinders, dampening unit, positions, and the like. The control system 177 has one or more control units 178 which preferably are memory programmable. This control unit 178 is connected, via a signal line 179, to the subordinate drive control 168. In the case of a plurality of control units 178, these are also connected to one another via the signal line 179, such as, for example, via a bus system 179.

The drive units 166 obtain, via the first network 171, the absolute and the dynamic information on the rotation of a shared, basic guide axis position φ, and obtain via a second signal pathway, and especially via at least a second network 176, the information necessary for register-true processing, and especially receive offset values Δφᵢ, for the register-true relative positioning of the drive units 166 or of the units that are mechanically independent from one another.

The features that are advantageous in the example of a printing press with a horizontal blanket-to-blanket printing group 03, specifically bearing assembly 14, drive coupling, motor configuration as a permanent magnet synchronous motor, can also be applied, individually or in combination, to I-printing units, such as blanket- to blanket printing groups 03 that are essentially rotated by 90 degrees. The features of the bearing assembly 14 and/or of the linear adjustment path and/or of the drive coupling, motor configuration can also be applied, individually or in combination, to nine- or ten-cylinder satellite printing units.

While preferred embodiments of drive units for a rotating component of a printing press, in accordance with the present invention, have been set forth fully and completely hereinabove, it will be apparent to one of skill in the art that changes in, for example, the specific structure of the forme cylinders and blanket cylinder with respect to their clamping arrangements and the like could be made without departing from the true spirit and scope of the present invention which is accordingly to be limited only by the amended claims.

What is claimed is:

1-52. (canceled)

53. A rotating cylinder of a printing press comprising:
a cylinder barrel of said rotating cylinder and having an axis of rotation and with spaced first and second end journals at first and second ends of said cylinder barrel, said rotating cylinder being a part of a blanket-to-blanket printing group;
first and second side frames of said printing press, said first and second side frames being generally parallel to each other and having inner frame faces spaced apart by a frame spacing distance;
a bearing assembly supported on each of said inner frame faces of said first and second side frames;
a movable bearing block in each said bearing assembly, each said bearing block being adapted to receive an end journal of said cylinder barrel;
means supporting each such bearing block in said bearing assembly for movement with respect to said respective one of said first and second side frames for movement of each said bearing block and said rotating cylinder in a direction of adjustment which is perpendicular to said axis of rotation of said rotatable cylinder, said spaced end journals of said rotating cylinder, when mounted on each of said respective bearing blocks, not extending through said respective ones of said first and second side frames;
a separate drive motor for said rotating cylinder and including a rotor rigidly and detachably connected to one of said end journals of said cylinder barrel, and further including a stator rigidly and detachably connected to said movable bearing block supporting said one of said end journals, said stator of said drive motor being movable with said bearing block during said adjustment of said rotating cylinder, said drive motor being a permanent magnet synchronous motor;
a rotatable cylinder length including said cylinder barrel and said spaced first and second end journals, said rotatable cylinder length being not greater than said frame spacing distance.

54. The rotating cylinder of claim 53 wherein said rotating cylinder is a transfer cylinder in said blanket-to-blanket printing group, said blanket-to-blanket printing group having four cylinders including said transfer cylinder, a first plane connecting rotational axes of said four cylinders in a print-on setting of said blanket-to-blanket printing group when said blanket-to-blanket printing group is a linear printing group, said plane forming an angle of not greater than 15° with respect to said direction of adjustment.

55. The rotating cylinder of claim 53 wherein said rotating cylinder is a transfer cylinder in said blanket-to-blanket printing group, said blanket-to-blanket printing group having four cylinders including said transfer cylinder, a first plane connecting said axis of rotation of said transfer cylinder and a cooperating one of said four cylinders defining a print point, when said blanket-to-blanket cylinder group is an angular printing group, said first plane forming an angle of not greater than 15° with respect to said direction of adjustment.

56. The rotating cylinder of claim 53 wherein said rotating cylinder is a forme cylinder and said blanket-to-blanket printing group is an angular blanket-to-blanket printing group and wherein a first plane defined by axes of rotation of said forme cylinder and a transfer cylinder cooperating directly with said forme cylinder extends at an angle of not greater than 15° with respect to said direction of adjustment.

57. The rotating cylinder of claim 53 further including a motor shaft, said motor shaft being detachably and torsion-proof connected to one of said journals, said rotor being detachably and torsion-proof connected to said motor shaft.

58. The rotating cylinder of claim 53 further including a clamping element extending through said side frame and being rigidly and detachably connected to said bearing block, said stator being rigidly and detachably connected to said clamping element exterior of said side frame.

59. The rotating cylinder of claim 53 wherein said bearing assembly includes stationary bearing elements.

60. The rotating cylinder of claim 53 wherein said drive motor is configured having no internal motor bearings between said stator and said rotor.

61. The rotating cylinder of claim 53 further including a radial bearing, usable to absorb radial forces between said stator and said rotor, is provided in said bearing assembly.

62. The rotating cylinder of claim 53 further including a support usable to prevent torsion in said drive motor and mounted on one of said side frames.

63. The rotating cylinder of claim 62 wherein said support is a guide.

64. The rotating cylinder of claim 53 further including permanent magnets secured to said rotation cylinder.

65. The rotating cylinder of claim 53 further including bearings between said stator and said rotor inside said motor.

66. The rotating cylinder of claim 53 wherein at least said rotor of said drive motor is coaxial with said cylinder barrel axis of rotation.

67. The rotating cylinder of claim 53 further including a motor shaft and wherein said rotor is detachably and torsion-proof connected to said motor shaft.

68. The rotating cylinder of claim 53 further including a clamping element connecting said rotor to said end journal.

69. The rotating cylinder of claim 67 further including a clamping element connecting said rotor and said motor shaft.

70. The rotating cylinder of claim 58 wherein said clamping element is a bushing.

71. The rotating cylinder of claim 53 further including a sensor usable to detect at least one of speed and angular position and having a sensor rotor connected in a torsionless manner to said motor rotor.

72. The rotating cylinder of claim 71 wherein said sensor stator has a radial degree of freedom of at least 2 mm.

73. The rotating cylinder of claim 53 wherein said motor rotor has permanent magnet poles.

74. The rotating cylinder of claim 53 further including a cooling device for said drive motor.

75. The rotating cylinder of claim 53 further including a rotary transformer on said drive motor.

76. The rotating cylinder of claim 53 further including first and second linear bearings in said bearing assembly and encompassing said bearing block.

77. The rotating cylinder of claim 53 further including an actuator in said bearing assembly and usable to implement said movement of said bearing block in said direction of adjustment.

78. The rotating cylinder of claim 76 wherein said first and second linear bearings are opposite each other and wherein said bearing block is encompassed by said first and second linear bearings wherein a bearing pre-tension and bearing forces accommodate an essential component in a direction perpendicular to said axis of rotation.

79. The rotating cylinder of claim 53 further including linear bearings in said bearing assembly and usable to allow said movement of said rotatable cylinder linearly.

80. The rotating cylinder of claim 79 wherein said rotating cylinder and said bearing unit are configured to be pre-installed.

81. The rotating cylinder of claim 53 further including a virtual guide axis for said printing machine and wherein said drive motor receives signals for at least one of angular position, angular speed and guide axis position from a signal line adapted to guide said virtual guide axis.

82. The rotating cylinder of claim 73 wherein said permanent magnets have rare-earth materials.

83. The rotating cylinder of claim 53 wherein said drive motor rotor is axially movable relative to said side frame and further wherein said rotor and said stator are movable axially relative to one another.

84. The rotating cylinder of claim 83 wherein said rotor is movable axially with respect to said cylinder.

85. The rotating cylinder of claim 84 wherein said stator is connected torsion-proof to said side frame.

86. The rotating cylinder of claim 85 further including a motor housing connected to said side frame rigidly in respect to compression and tension in said axial direction of said cylinder.

87. The rotating cylinder of claim 86 wherein said bearing is connected to said bearing assembly, which bearing assembly is mounted to said side frame rigid to compression and tension in said axial direction of said cylinder.

88. The rotating cylinder of claim 84 wherein said rotor is connected to said cylinder rigid to compression and tension in said axial direction of said cylinder.

89. The rotating cylinder of claim 83 wherein said stator is stationary in an axial direction of said cylinder.

90. The rotating cylinder of claim 53 further including at least one stator signal on said stator and having a stator section effective surface adapted to interact with said rotor, said stator segment surface extending in a circumferential direction over an angular segment less than 360°.

91. The rotating cylinder of claim 90 wherein there is only one said stator segment.

92. The rotating cylinder of claim 90 wherein there are at least two of said stator segments adapted to interact with said rotor and spaced from each other in a circumferential direction.

93. The rotating cylinder of claim 90 wherein said at least one stator segment covers a circumferential distance of less than 3600.

94. The rotating cylinder of claim 93 wherein said at least one stator segment covers a circumferential distance of less than 240°.

95. The rotating cylinder of claim 53 wherein said rotor includes a plurality of circumferentially spaced individual rotor segments which are adapted to be mounted on a shaft.

96. The rotating cylinder of claim 95 wherein said plurality of rotor segments extend around 360° of a circumference of said shaft.

97. The rotating cylinder of claim 95 wherein said rotor segments include permanent magnets.

98. The rotating cylinder of claim 95 wherein said rotor segments include windings adapted to generate an electrical magnetic field.

99. The rotating cylinder of claim 53 wherein said drive motor is an external-rotor motor and having an internal stator.

100. The rotating cylinder of claim 53 wherein said drive motor is an internal-rotor motor and having an external stator.
